(19) United States
(12) Patent Application Publication
(10) Pub. No.: US 2006/0178994 A1
(43) Pub. Date: Aug. 10, 2006

(54) Method and system for private shipping to anonymous users of a computer network

(76) Inventors: Salvatore J. Stolfo, Ridgewood, NJ (US); Jonathan M. Smith, Princeton, NJ (US); Jeffrey D. Chung, Fremont, CA (US)

Correspondence Address: MORGAN LEWIS & BOCKIUS LLP, 1111 PENNSYLVANIA AVENUE NW, WASHINGTON, DC, 20004, US

(21) Appl. No.: 11/233,212

(22) Filed: Sep. 21, 2005

Related U.S. Application Data
(63) Continuation-in-part of application No. 10/441,844, filed on May 19, 2003, now Pat. No. 7,069,249.
(63) Continuation-in-part of application No. 09/754,897, filed on Jan. 5, 2001, now abandoned.
Application No. 10/441,844 is a continuation of application No. 09/360,812, filed on Jul. 26, 1999, now abandoned.
(60) Provisional application No. 60/174,638, filed on Jan. 5, 2000.

(51) Int. Cl. G06Q 99/00

(52) U.S. Cl. 705/50

(57) ABSTRACT

A method and system for private shipping to anonymous users purchasing goods on a computer or communications network linking users with merchant web-sites for electronic commerce. In a preferred embodiment, a user is issued a proxy identity and the user's mailing address is received and encrypted. The proxy identity and encrypted mailing address are transmitted to a merchant, and decryption information is provided to a shipper. Upon receipt of the encrypted shipping address from the merchant, the shipper can use the decryption information to decrypt the address and generate a package label bearing the true shipping address of the user so that the merchant is prevented from electronically capturing the true identity of the user. The present invention provides for anonymity of a user when browsing and shopping, and integrates easily and simply with existing online infrastructures of banks or credit card issuers, and delivery companies.

### CROSS REFERENCE TO RELATED APPLICATIONS

This application is a continuation-in-part of application Ser. No. 10/441,844, filed May 19, 2003 for “Electronic Purchase of Goods over a Communication Network Including Physical Delivery While Securing Private and Personal Information of the Purchasing Party” and a continuation-in-part of application Ser. No. 09/754,897, filed Jan. 5, 2001 for “Method and System for Private Shipping to Anonymous Users of a Computer Network.” The '844 application is a continuation of application Ser. No. 09/360,812, filed Jul. 26, 1999, now abandoned. The '897 application claims benefit of provisional patent application Ser. No. 60/174,638, filed Jan. 5, 2000. All of these applications are incorporated herein by reference in their entirety.

### FIELD OF THE INVENTION

The present invention relates generally to networks and, more particularly, to a method and system that allows users to securely order and receive packages from merchants, without revealing their true identities to those merchants or any other network users, and without compromising their financial information.

### BACKGROUND OF THE INVENTION

As used herein, the term computer includes any device or machine capable of accepting data, applying prescribed processes to the data, and supplying the results of the processes. By way of example, but not limitation, the term “computer” includes mainframe computers, servers, personal computers, laptops, personal digital assistants, portable phones, cell phones, and calculators. The term “communications network” is also meant in a broad sense, and may include any suitable technology for information transmission, including electrical, electromagnetic and optical technologies. Such a communications network may link computers, e.g., a LAN or WAN. Although the invention is described with particular reference to an open network, such as the Internet, it may also be used in other networks, internets and intranets.

The Internet continues to increase in importance as a place for business, offering a wide variety of information and services to potential customers. However, as an open network, the Internet provides opportunities to legally and illegally collect and use vast amounts of information which people consider both private and personal, and increasing concerns about privacy, fraud and security online could inhibit the continued growth of business-to-consumer “electronic commerce.”

Currently, shopping, browsing and other information-sharing activities on the Internet expose users to unwanted collection of their private and personal information, from which their identities, activities, behaviors and preferences can be ascertained. For example, without a user's permission, web marketers and merchants often gather “click data” that details every web-site a user visits with his or her browser. Underlying communications protocols and systems may provide additional private and/or personal information. In addition, users are often asked for, and provide, personal information about themselves in order to become a “member” of a particular web-site. This data is then used to create demographic profiles linked with the user's identity, including their name, postal address and e-mail address, gender, age, and other personal information. This information is routinely bought and sold among parties who link and merge the information with other transaction data from other sources (i.e., “data mining”) offered for sale by third parties and vendors to create a sophisticated and detailed behavior profile of users, in order to target those users for advertising. This unwarranted level of intrusion into the private information of a user, often unknown to the user, is perceived as a fundamental threat to personal freedoms, creating an outcry among a number of privacy groups and a potential impediment to the growth of e-commerce. The above-referenced U.S. patent application Ser. No. 09/360,812, to one of the present inventors, discusses these privacy concerns.

### SUMMARY OF THE INVENTION

In accordance with one aspect of the invention, communications and/or a transaction can be carried out between a user or first party, typically a consumer, or a prospective or actual purchaser or customer, and a second party, typically a merchant, retailer or vendor, over a communications network linking the first and second parties, in which information is provided and/or a good is ordered, and/or purchased and/or paid for and/or delivered, while securing such information of the first party with respect at least to the second party. The invention provides methods, systems and software for doing this and other things.

In accordance with another aspect of the invention, delivery of a physical good may be made to a physical address of a physical facility designated by the first party which may be a depot for pick-up anonymously by or on behalf of first party, or a second or last address while securing private information of the first party at least with respect to the second party. The first party may designate any appropriate physical address (e.g., residence or business), including an address related to another party, e.g., a friend or a party to whom the good is delivered as a gift. In accordance with the invention, an electronic good may be delivered to an electronic address designated by the first party while securing the private and personal information of the first party with respect to other parties.

In one embodiment, a user or first party may communicate over the network with a second party, using a proxy. The proxy may provide a different identity for a user for a set of communications (e.g., browsing) or for each transaction. Thus, the user has a different identity each time it establishes communication with a second party or for each transaction. For example, the proxy may use a unique session number (#F) generated by the proxy for each transaction to provide a unique alphanumeric name that is supplied to the second party vendors. In a sense, the proxy party is anonymized or privatized vis a vis the second party. Also, vendors will not be able to compile any use history on any user since new or unique proxy identities generated automatically cannot be linked with other transactions over time.

Alternatively, the proxy may provide the same identity for a user for all communications and transactions. In this embodiment, the proxy can provide a user name which is a function of a unique name or proxy identifier (I) of each user and the proxy's identity (public identity) (P) for each transaction. This user name is the same for each user for all transactions and communications for all vendors. This, a user history may be compiled by vendors and others for a user who is anonymous to them.

The proxy may also alter information from the first party directed to the network or the second party so that the second party can not ascertain the first party's private and personal information. The proxy may also provide for payment and/or delivery of an ordered identity. The proxy may or may not know the true identity of the first party, or any private or personal information of the first party.

Today commerce is typically conducted using credit card accounts issued by banks or credit card issuers, and delivery of physical goods is provided by shipping or delivery companies. The technical infrastructure and systems in use have been designed, developed and deployed over many years, certainly pre-dating the existence of the new technical infrastructure of the Internet and the World-Wide-Web. Furthermore, the existing transaction and delivery infrastructures involve complicated labor rules that manage worker procedures in order to optimize the process of performing many millions of transactions each day to reduce costs and maintain transaction speeds and throughputs (for very large volumes) and minimize delivery time (for guaranteed time limits of delivery, e.g., overnight delivery) for millions of packages each day. In order to provide private transactions and private shipping features on the Internet or Web, it is the goal of the present invention to integrate with the existing technical infrastructure of banks or credit card issuers and shipping or delivery companies in an easy and scalable fashion.

Credit card transactions are performed by customers at point of sale terminals (e.g., retail outlets), that are electronically attached to “acquirer” systems that route transaction information over private networks (e.g., the MASTERCARD® network) to banks or credit card issuers for authorization of the transaction. These communication networks are “private” utilizing systems, employing protocols that are different from the infrastructure of the Internet and World-Wide-Web. Integrating these older private communication networks with the Internet is a difficult and challenging task. It is a goal of the present invention to provide an easy means of integrating with bank or credit card issuer's existing authorization systems for private shopping and anonymous transacting.

It is a further goal of the invention that this integration will not change existing labor work rules and procedures. For example, in the case of delivery of physical goods, a merchant will typically print a label with the address of the recipient when the order is shipped. The physical, printed label is used by delivery company employees to route and physically move the labeled packaged through a complicated delivery system until it reaches by hand delivery its final destination. The physical, printed label is the most important information available to the delivery employee, and any change to the process will slow down delivery time. For example, for private shipping, re-labeling a package in order to redirect it to maintain customer anonymity (see, e.g. U.S. patent application Ser. No. 09/360,812) will cause serious delay and costly new technical systems needed to change a proxy address to a real shipping address. It is therefore another goal of the present invention to print a single label on a package that maintains the privacy of the customer and prevents the merchant from gaining easy access to the true identity of the recipient.

In a system with end-to-end privacy protection for online surfing and shopping, several important problems exist in integrating with existing online systems of large corporations, including banks or credit card issuers, and delivery companies. The size and scale of the markets each of these respective industries serve is so large that scaling online systems available over the Internet is extremely difficult. Most transactions are now performed using credit card accounts, each identified by a fixed length string of numbers that is inherently finite and limited in range. In the private surfing and shopping system disclosed in U.S. patent application Ser. No. 09/360,812, several issues have been noted:
(a) Will the banks or credit card issuers be able to do an online preauthorization in a very short time frame before the merchant web form is submitted to the merchant? The answer is apparently YES, but not without great expense to maintain the transaction throughputs demanded by market conditions.
(b) Will the banks or credit card issuers be able to generate multiple credit card numbers linked to a specific single credit card account? Each of these linked credit card numbers would be issued under a pseudonym for private shopping. The answer is apparently NO for the MASTERCARD®/VISA® issuers, but likely a definite YES for AMERICAN EXPRESS®.
(c) Will the banks or credit card issuers be able to assign a pool of card numbers used by a large collection of its customers? Here, an anonymous user would be granted permission to use one of these pooled numbers for a specific transaction to provide anonymity of their own identity and financial information. The answer is apparently NO.
d) Can the total amount of a purchase be extracted from a web page displayed in the customer's browser with high accuracy. Possible, but now probably not necessary.
   Another aspect of the present invention dramatically simplifies the process under the constraints naturally imposed by the negative answers to (a)-(d).

In a preferred embodiment, the present invention is a method for providing private shipping of items to anonymous users purchasing goods on a computer-based communications network comprising the steps of: providing a proxy identity to a user; receiving a shipping address for the user; partially encrypting the user's shipping address; transmitting the proxy identity and encrypted shipping address to a merchant; and providing decryption information to a shipper; whereby upon receipt of the encrypted shipping address from the merchant, the shipper can use the decryption information to decrypt the address and generate a package label bearing the true shipping address of the user so that the merchant is prevented from electronically capturing the true identity of the user. The proxy identity may comprise a proxy name and a proxy credit card account, and a new and different proxy name may be generated for the user for each shopping transaction or session. The shipping address may be encrypted so that the numerical information required for authorization under the Address Verification System is preserved. The communications network may be the Internet, and the user's proxy identity may be stored in a digital wallet on a user computer.

The step of issuing a proxy identity may include issuing a physical integrated circuit card to the user, and the proxy identity may be authenticated by reading the integrated circuit card via a card reader.

In a preferred embodiment, the encrypted shipping address contains sufficient information to allow the merchant to calculate an appropriate transaction tax, i.e., state sales tax. In still other embodiments, the method may further comprise maintaining a secure database of user transaction information, and providing access to the database to a shipper to resolve a shipping problem. The transaction information stored in the secure database may include instructions for returning items that are undeliverable.

The user's encrypted shipping address may contain an identifier that may be used as an electronic mail address to contact the user. The present invention may further comprise the step of generating a unique shopping session identification number, and the encrypted shipping address may be a function of the shopping session identification number. In still another embodiment, the encrypted shipping address is a function of time.

In another embodiment, a user selects a privacy level for a shipment, and a corresponding encryption algorithm for the user's shipping address is applied based upon the selected privacy level.

In still another embodiment, the present invention is a system for providing private shipping of items to users purchasing goods on a computer-based communications network comprising: a secure server computer including a processor configured to generate a proxy identity for a user, receive a shipping address for the user, and partially encrypt the user's shipping address; a database configured to store user identity information and transaction data; and a communications link for transmitting the proxy identity and partially encrypted shipping address to a merchant; so that the merchant is prevented from electronically capturing the true identity of the user. The processor may be configured to generate a unique shopping session identification number, and the user's encrypted shipping address may be a function of the shopping session identification number. The user's encrypted shipping address may also be a function of time.

### BRIEF DESCRIPTION OF THE DRAWINGS

The present invention will be understood and appreciated more fully from the following detailed description, taken in conjunction with the drawings in which:

FIG. 1 is a block diagram illustrating a system of the present invention;

FIG. 2 is a flowchart illustrating the steps in a preferred embodiment of the method of the present invention;

FIG. 3 is a block diagram of an embodiment of a system incorporating the invention for the purchase of goods over the Internet and payment for the goods;

FIG. 3A is a block diagram of an alternate embodiment of system depicted in FIG. 3 showing a delivery facility as part of the system;

FIG. 3B is a block diagram of an embodiment of a system which provides for purchase and payment and delivery of goods over the Internet.

FIG. 3C is a block diagram of a portion of system depicted in FIG. 3 showing an additional party (fourth party) as part of the system depicted in FIG. 3B;

FIG. 3D is a block diagram of an alternate embodiment of a system incorporating the invention for the purchase of goods over the Internet without a proxy;

FIGS. 3E-3H are flow diagrams showing credit approval and crediting/debiting of the parties involved in a transaction for various embodiments;

FIG. 4 is a block and flow diagram illustrating an electronic purchase made using the system depicted in FIG. 3B;

FIGS. 4A-4Q illustrate specific steps and data flows carried out using the system depicted in FIG. 3B;

FIG. 5 is a diagram illustrating transaction authorization and netting procedures carried out by the system depicted in FIG. 3B;

FIG. 6 is data diagram representing data generated in a transaction using the system depicted in FIG. 3B stored by the third party bank;

FIG. 7 is a data diagram representing data generated in a transaction using the system depicted in FIG. 3B stored by the proxy;

FIG. 8 is a table showing data generated during a transaction and the parties who have access to the data;

FIG. 9 is a diagram showing IP protocol layers of IP packets processed by first party (user) computers, proxy party computers and second party computers in the system depicted in FIG. 3C.

### DETAILED DESCRIPTION OF THE PREFERRED EMBODIMENTS

Prior art shipping and delivery systems for physical goods are entirely dependent upon the printed address label. Typically, delivery companies provide merchants software for printing these labels. This software receives electronic information concerning the recipients' identity and shipping address from merchant order entry systems, and prints address information on paper labels that are then affixed to packages for delivery.

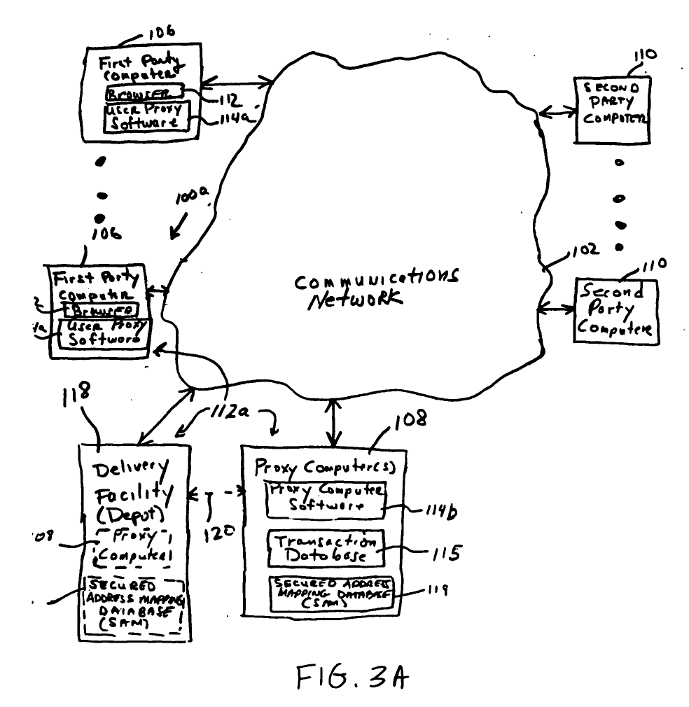

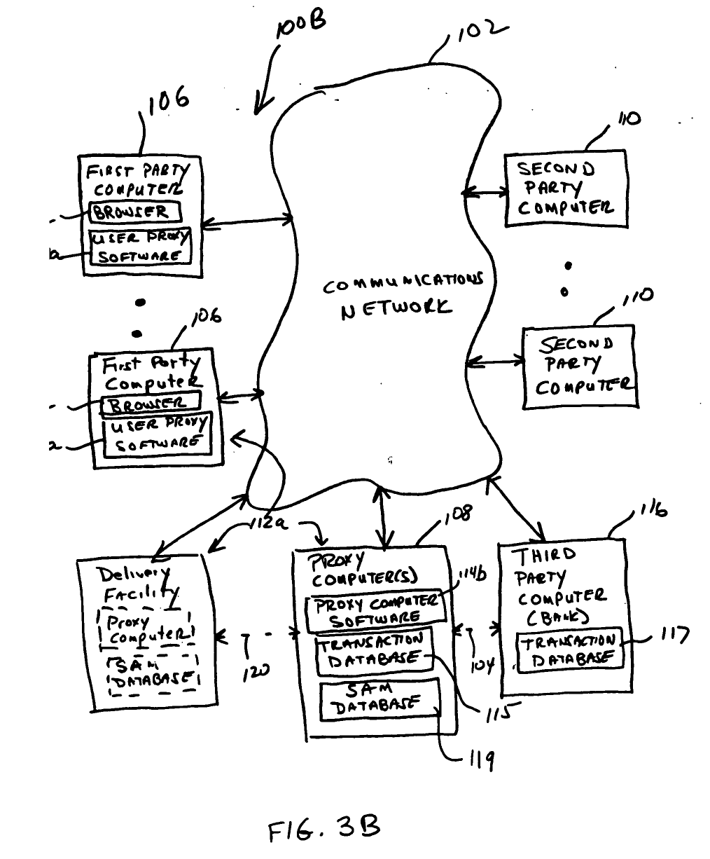

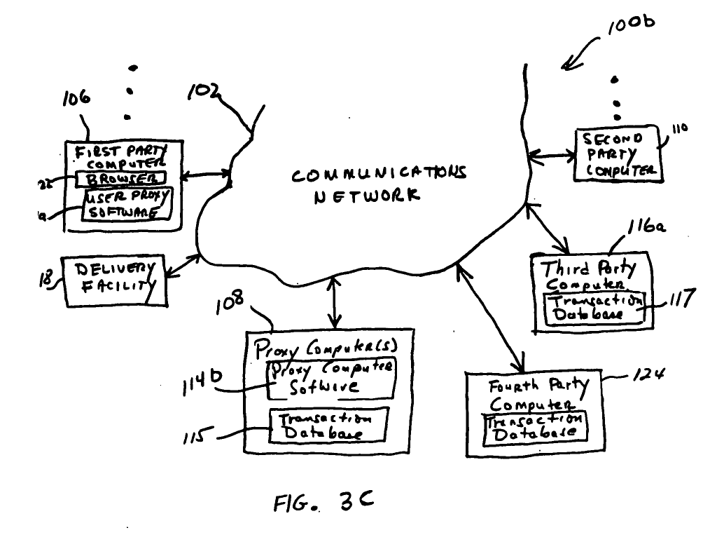

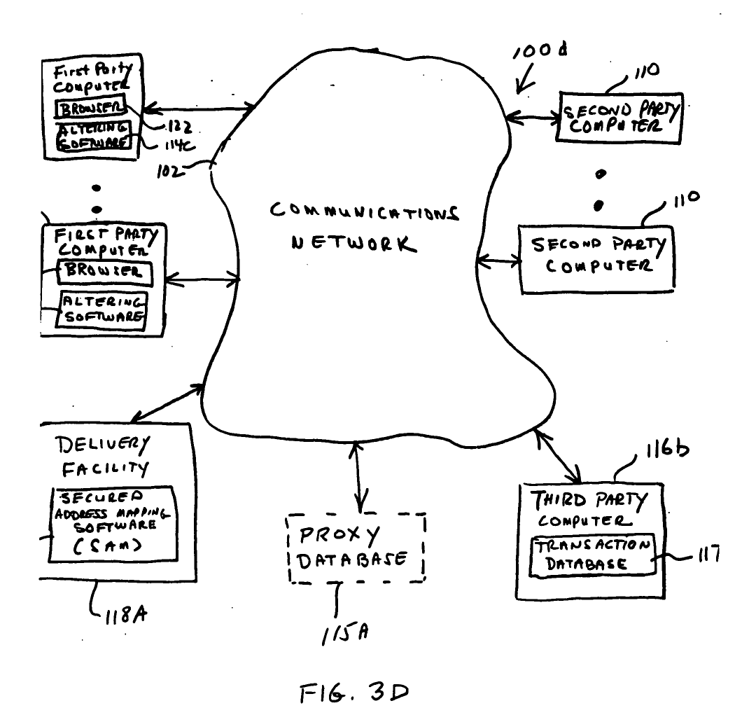

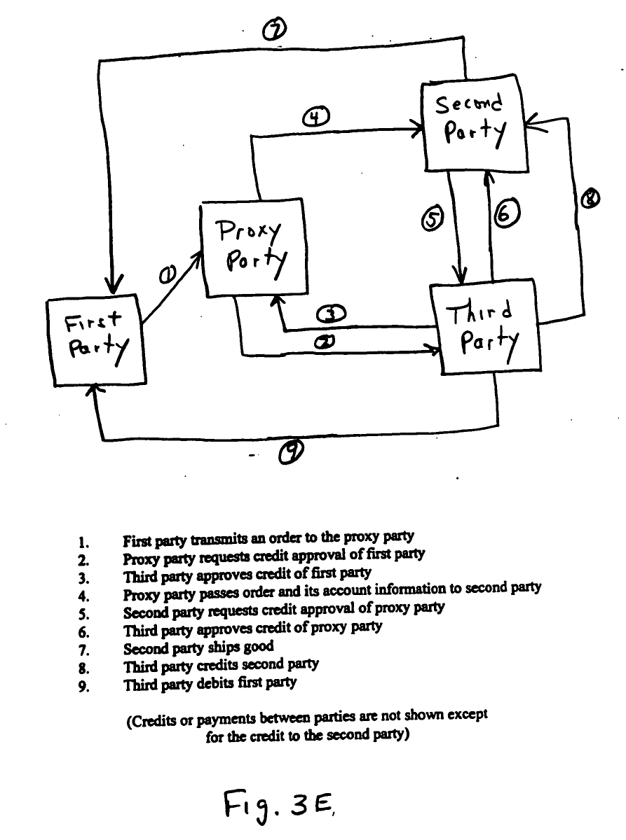

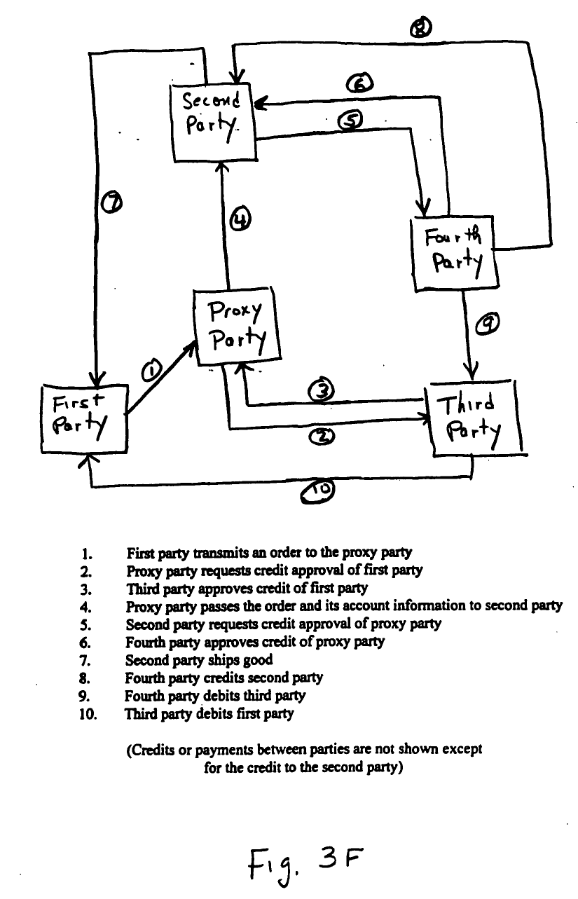

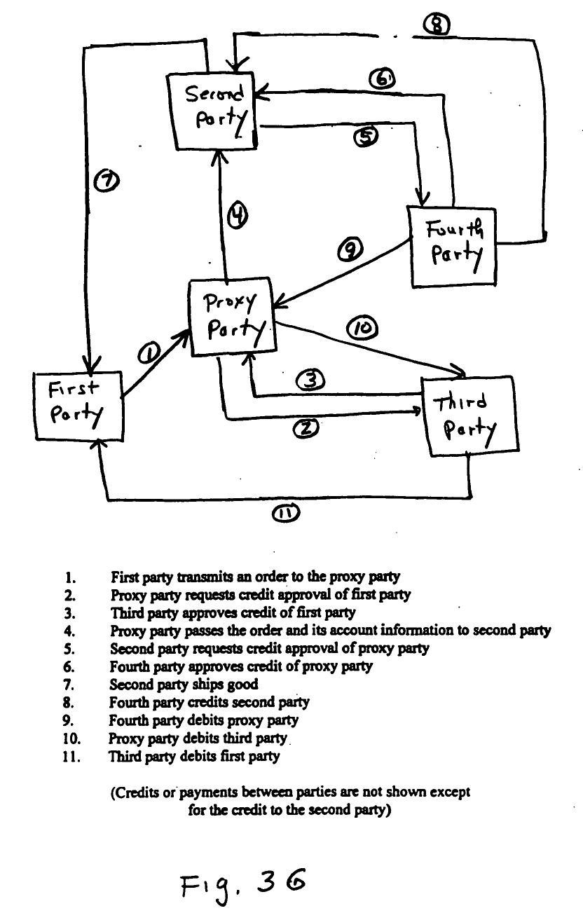

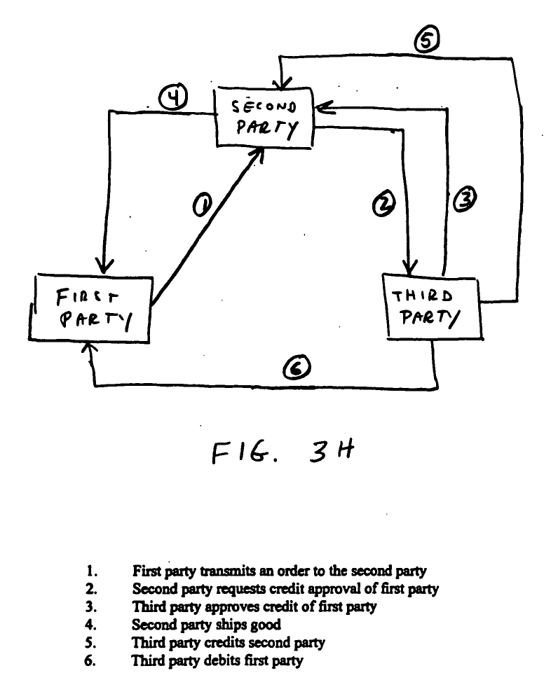

The overall architecture of systems with a central proxy incorporating the invention can be implemented in different ways, some of which are illustrated in FIGS. 3, 3A, 3B and 3C which depict a system 100, 100a, 100b, 100c linked by the Internet 102 and optionally by one or more secure transmission links 104 for conducting e-commerce over the Internet and World Wide Web between first party customers, represented by first party computers 106, and second party merchants, represented by second party computers 110 through a proxy system 112, 112a which includes proxy computer(s) 108 and proxy software 114. The proxy computer(s) 108 represent a proxy party or proxy system operator. A third party, represented by third party computer(s) 116, pays (credits) second party merchants for respective goods purchased by first party customers and debits the accounts of respective first party customers.

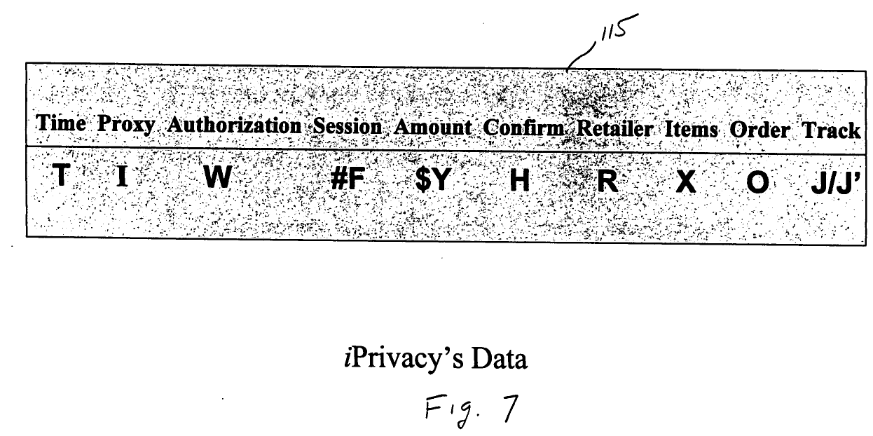

Referring to FIG. 3, the proxy system 112 may include one or more databases for storing transaction data. For example, a transaction database 115 that stores transaction data (e.g., as shown in FIG. 7) may be provided that links transaction data, as described below. Other parties such as the third party bank 116 may also have a database such as a transaction database 117 that stores transaction data (e.g., as shown in FIG. 6). As pointed out above, by logging data such as returns, complaints, delivery times, damaged goods, etc. in the proxy transaction data base, or in another database maintained by the proxy, vendor performance can be measured.

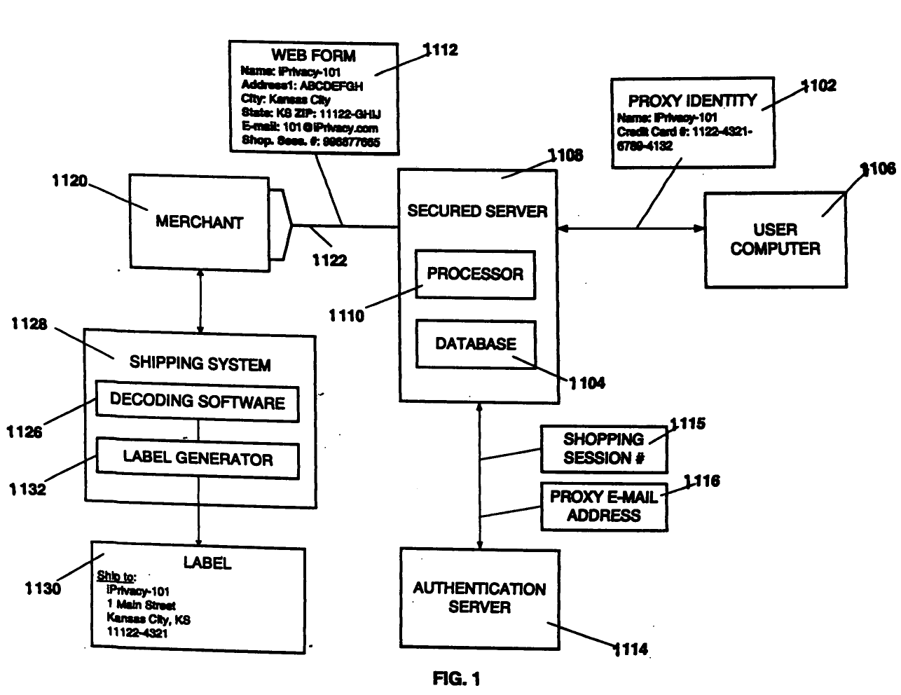

The first party can elect to communicate and transact directly with the second party to conventionally, as in FIG. 1, or through the proxy system 112 represented in FIG. 3. If privacy is wanted, communicating or transacting with a second party is handled through the proxy system 112. The proxy software 114 secures the first party's private and personal information with respect to unauthorized parties and provides information necessary for an e-commerce transaction which routes the transaction through the proxy system 112 and is identifies the proxy party (i.e., the proxy system operator) as the transactor.

The proxy software 114 may be executed by the proxy computer(s) 108, or distributed and executed by both first party computers 106 and proxy computer(s) 108. FIG. 3 depicts an embodiment in which the proxy software 114 is distributed, part 114a being executed by user computers 106 and part 114b being executed by proxy computer(s) 108. The first party computers 106 may function as client computers, and the proxy party computer(s) 108 and the third party computers 106 may function as server computers. For convenience, and to more easily differentiate the proxy software parts, proxy software 114a executed by first party computers 106 is referred to as user proxy software 114a, and proxy software 114b executed by a proxy computer 108 is referred to proxy computer software 114b.

A system 112a which may provide for delivery of physical goods, and as illustrated in FIG. 3A, includes a physical or virtual delivery facility 118 to which a good ordered by a first party customer is delivered while securing the identity of the first party. The delivery facility 118 may be linked to a proxy computer 108 through the Internet or a secure link 120, and may include one or more proxy computers 108. A secured address mapping (SAM) database 119 may be provided to link users with their physical or electronic shipping addresses. The SAM 119 database may be located within a proxy computer 108 that communicates with first party computers or at a delivery facility 118, or at another location accessible over the Internet (preferably over a secured channel).

Thus, FIGS. 3 and 3A respectively represent embodiments in which payment for purchase of a good is achieved over the Internet while securing the private and personal information of the purchaser with respect to unauthorized parties, and in which physical delivery of a good ordered over the Internet is achieved while securing the private and personal information of the purchaser with respect to unauthorized parties. In the preferred embodiment, the system 100b show in FIG. 3B provides for both payment and delivery and is represented by combining FIGS. 3 and 3A, i.e., FIG. 3B includes the delivery facility 118 and the SAM database 119 at the delivery facility and/or the proxy computer(s) and/or at another location.

In the systems 100, 100b depicted in FIGS. 3 and 3B, both first parties and the proxy party have accounts with the third party 116 (bank or credit card company, etc.), and third party 116 performs credit clearing and provides for payment (credit) to a second party and debiting of a first party involved in a particular transaction, and also crediting the proxy party with a part of the service charge, as described in more detail below. FIG. 3C illustrates a system 100c which includes two parties, third party 116a and fourth party 124, involved in credit clearing and payment for a purchase, and represents an alternate embodiment of the system 100b depicted in FIG. 3B. The third party 116a may be a bank or credit card company, etc., as in FIG. 313, with which a first party has an account, and the fourth party 124 may be another bank or credit card company with which the proxy party has an account. Third party 116a clears credit card transactions with respect to the fast party and fourth party to 124 clears credit card transactions with respect to the proxy party. The third and fourth parties settle, where, generally, the fourth party pays the second party, and debits the proxy party's account with the fourth party, and the third party pays the proxy party by crediting the proxy party's account with the fourth party and debits the first party's account with the third party, as described in more detail below.

FIG. 3D shows the embodiment that does not require a proxy. System 100d includes first party computers 106 which include a browser 122 and altering software 114c which performs the filtering described in connection with the proxy software. System 100d also includes a delivery facility similar to delivery facility 118 but operated by the third party 116. Second party computers 110 and a third party computer 116b are similar to those in system 100b shown in FIG. 3B. System 100d may also include a central transaction or proxy database 115a which stores transaction data for safe keeping and later retrieval by the parties in the event of a return, or a dispute, etc.

Referring to FIG. 3B, each first party computer 106 accesses the Internet and navigates the World Wide Web with browser software 122 (e.g., Internet Explorer® and Netscape Navigator®). A first party computer 106 may access the Internet and navigate directly without using the proxy system 112, or through proxy computer(s) 108 using the proxy system 112, as described below.

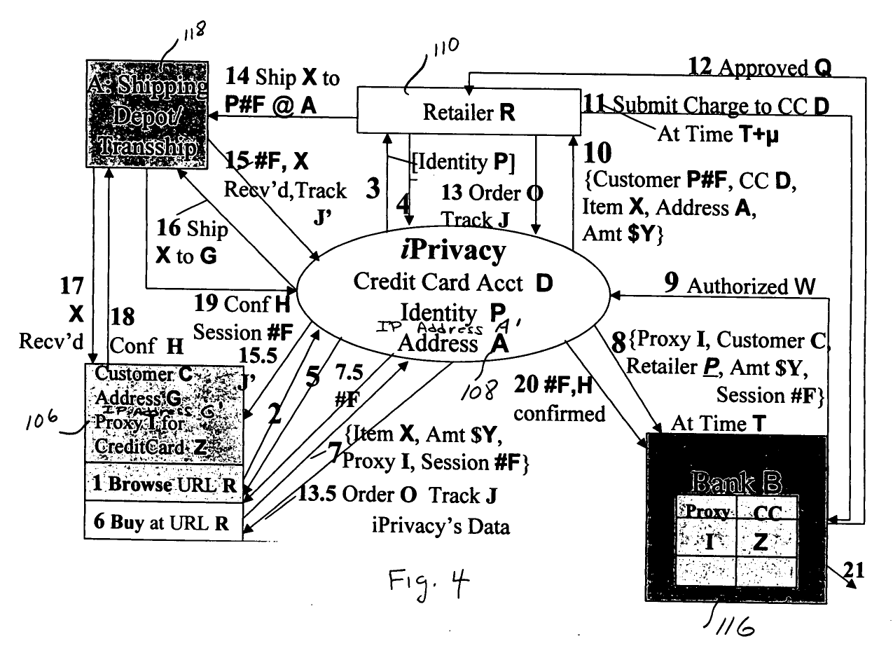

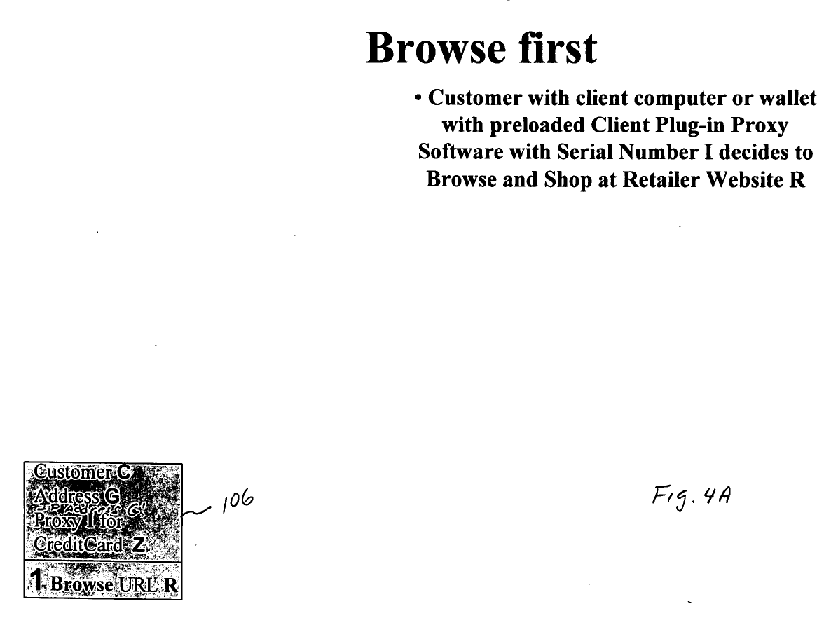

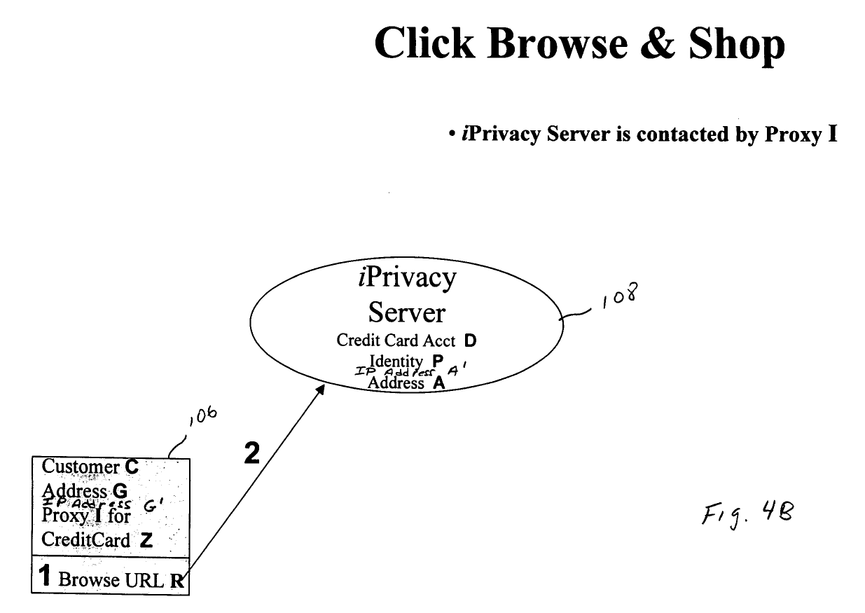

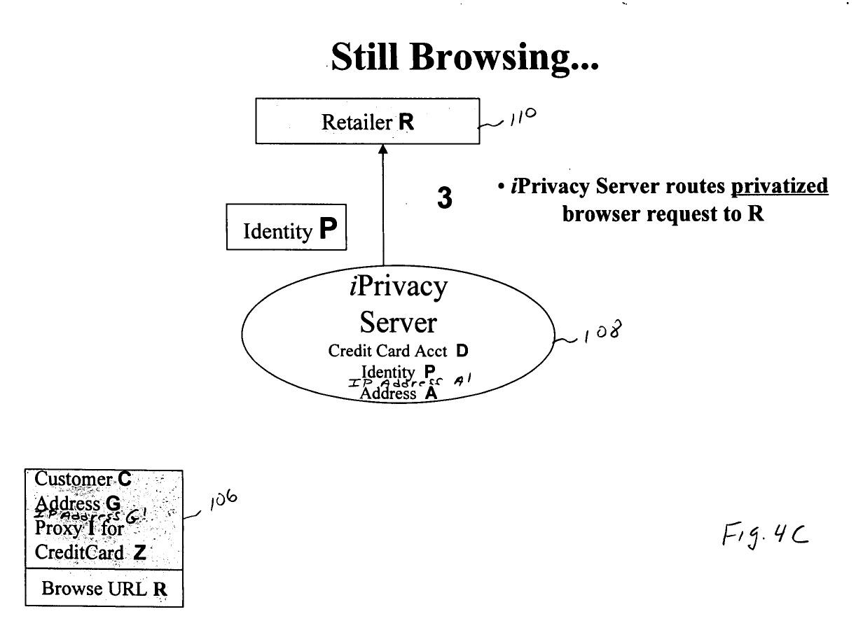

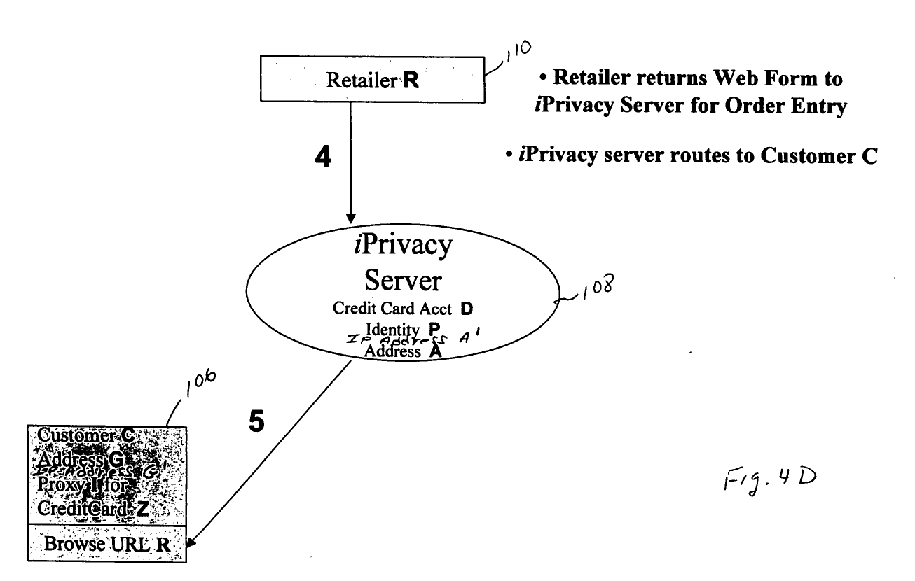

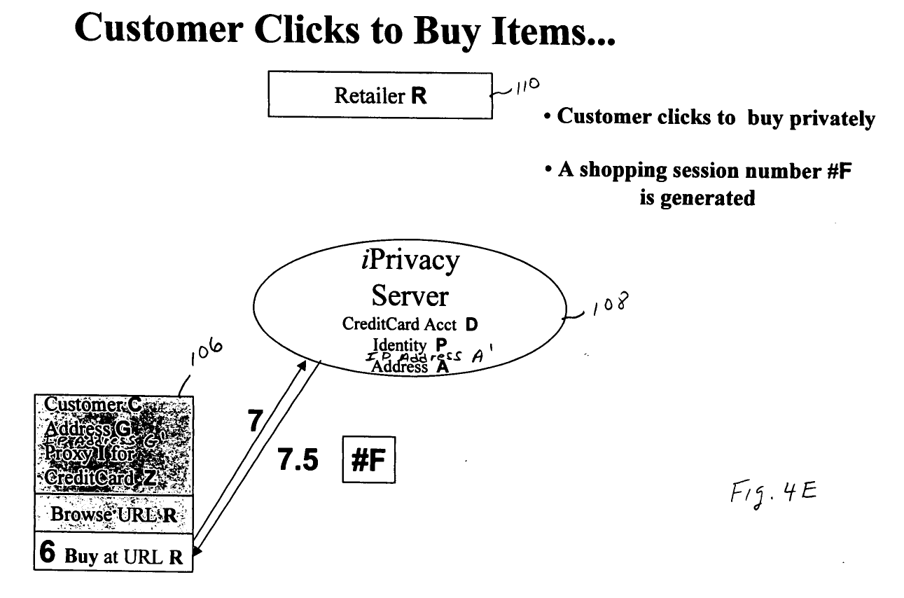

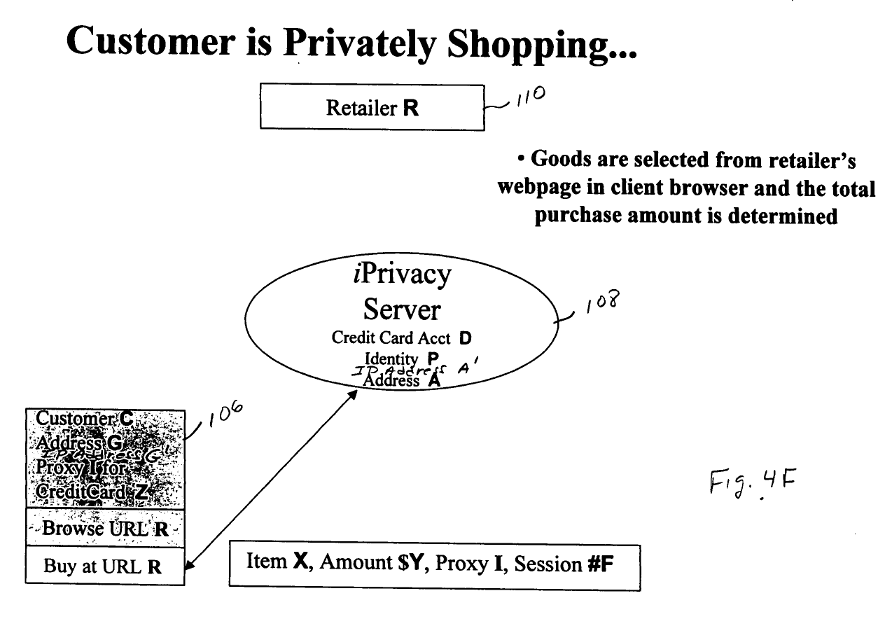

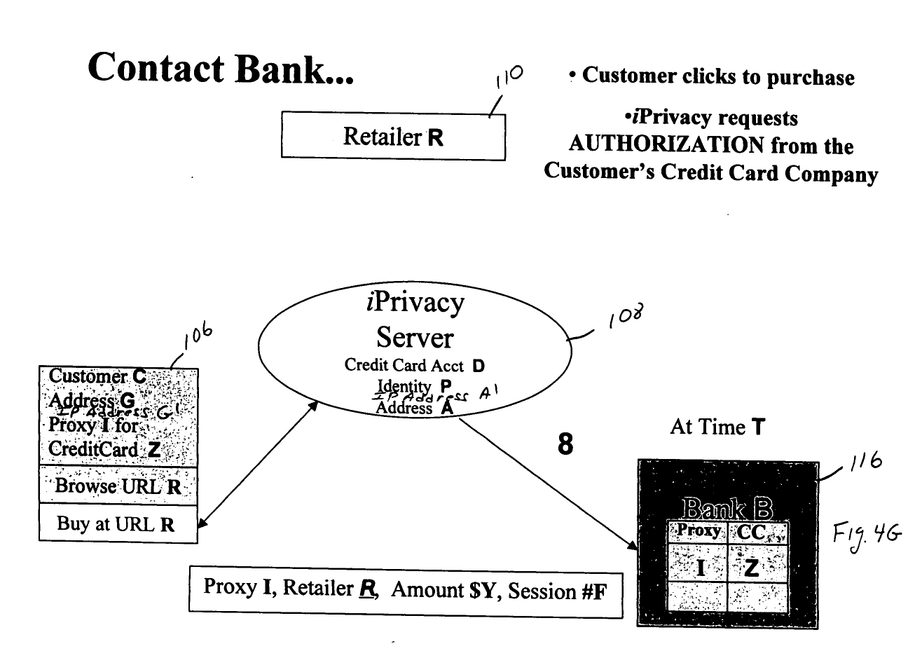

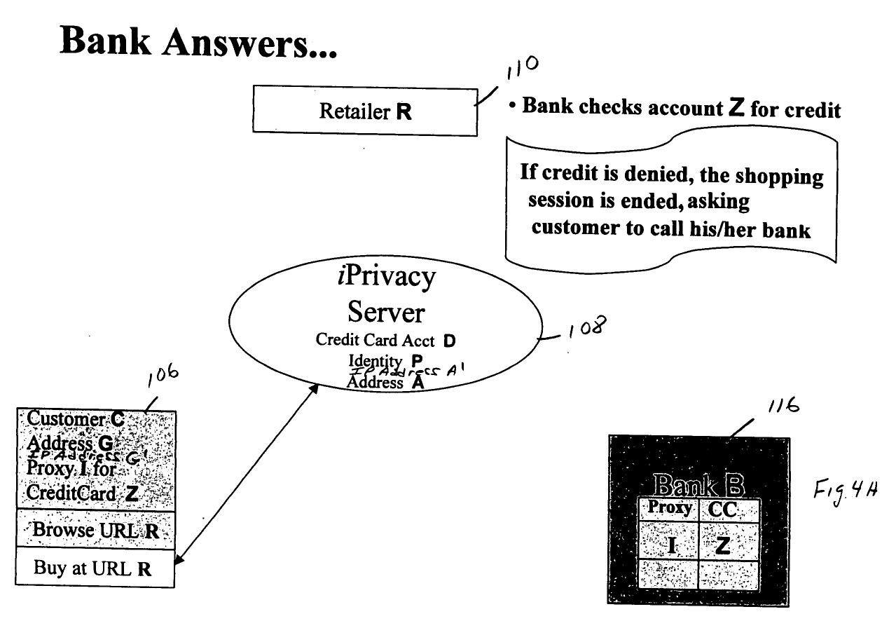

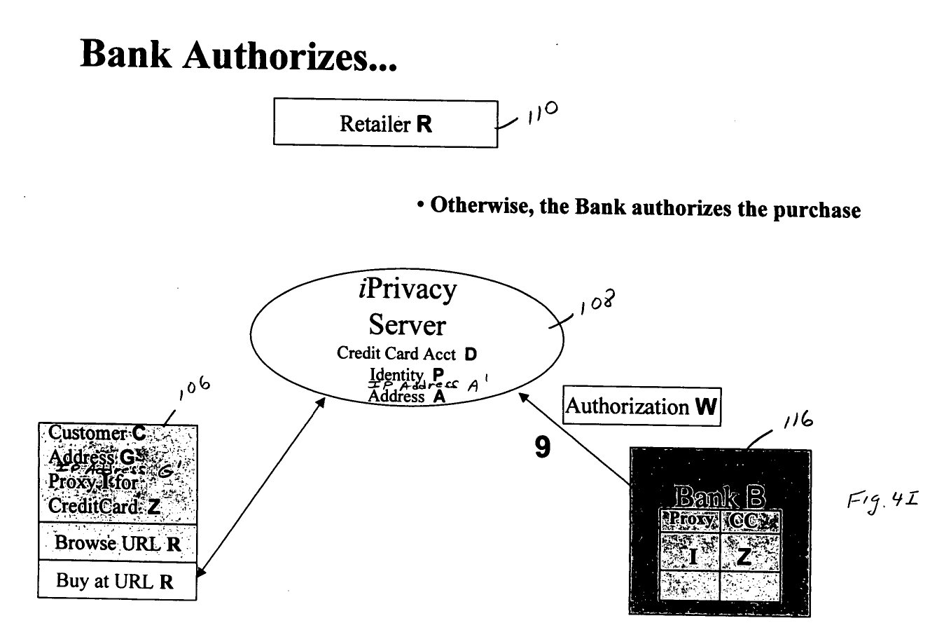

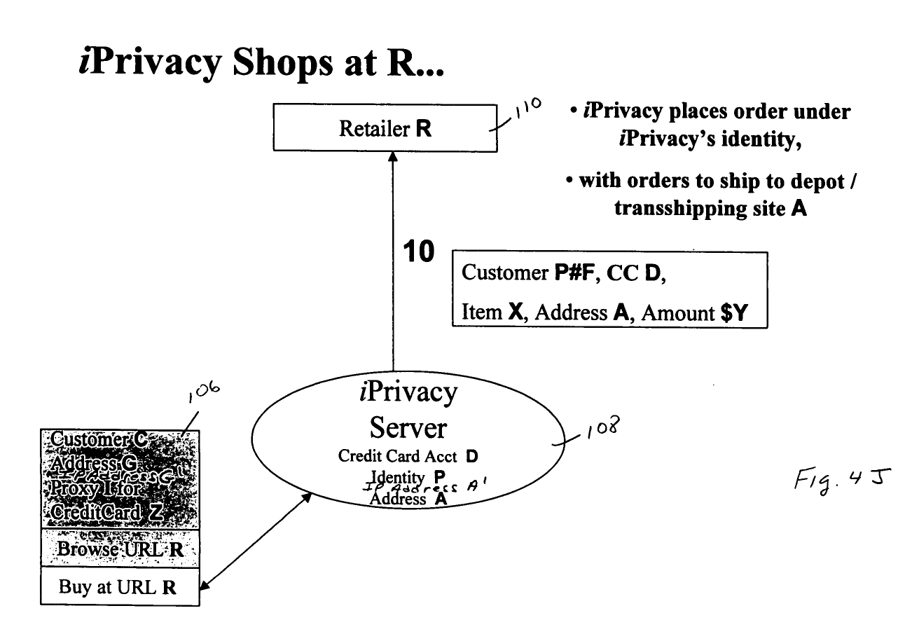

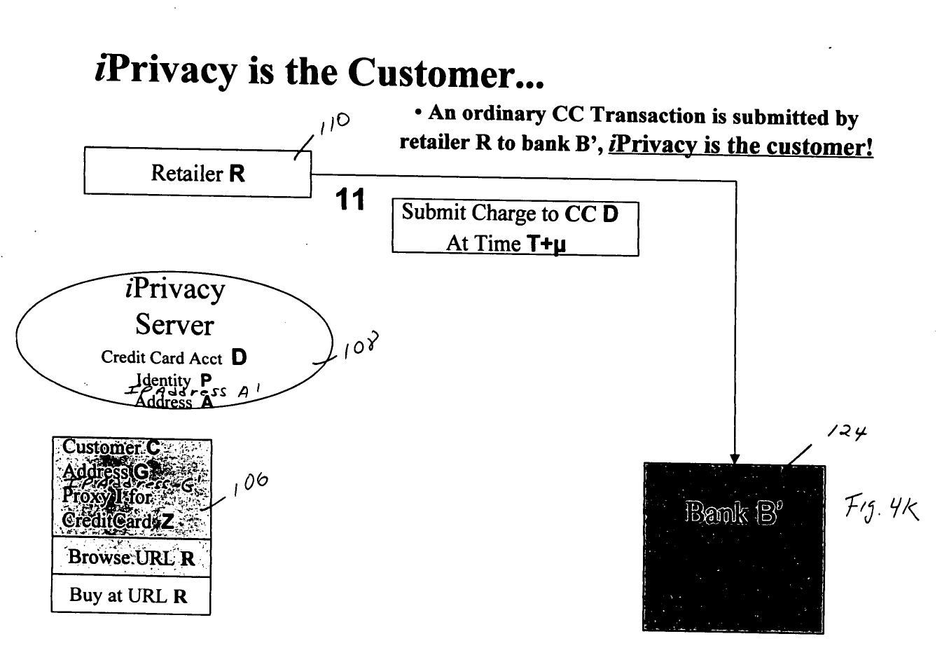

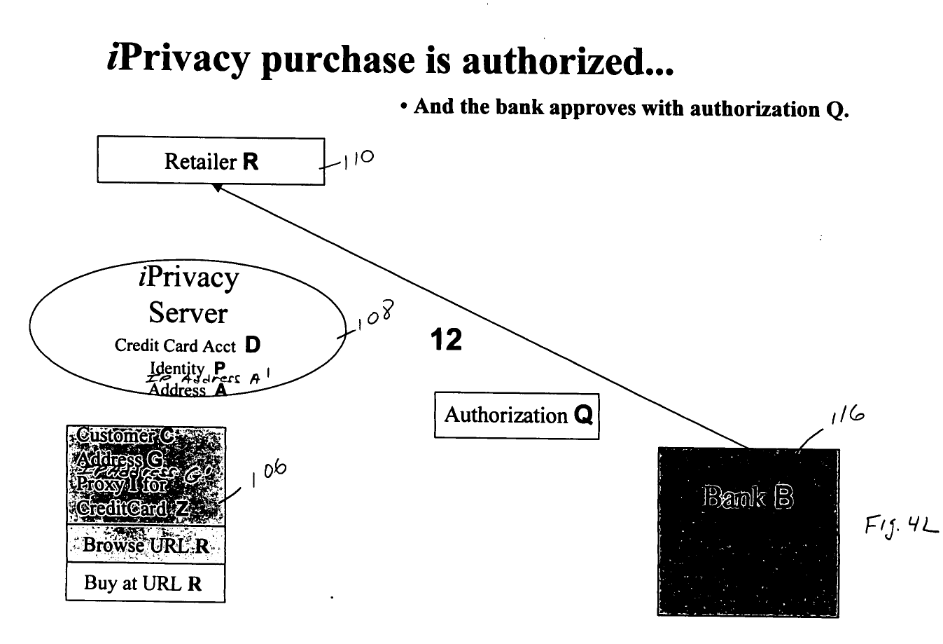

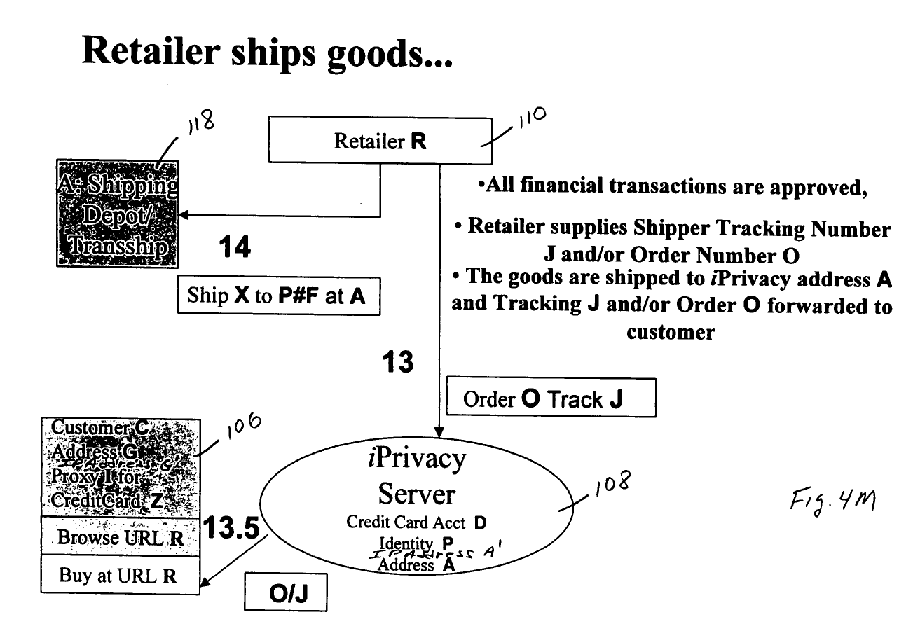

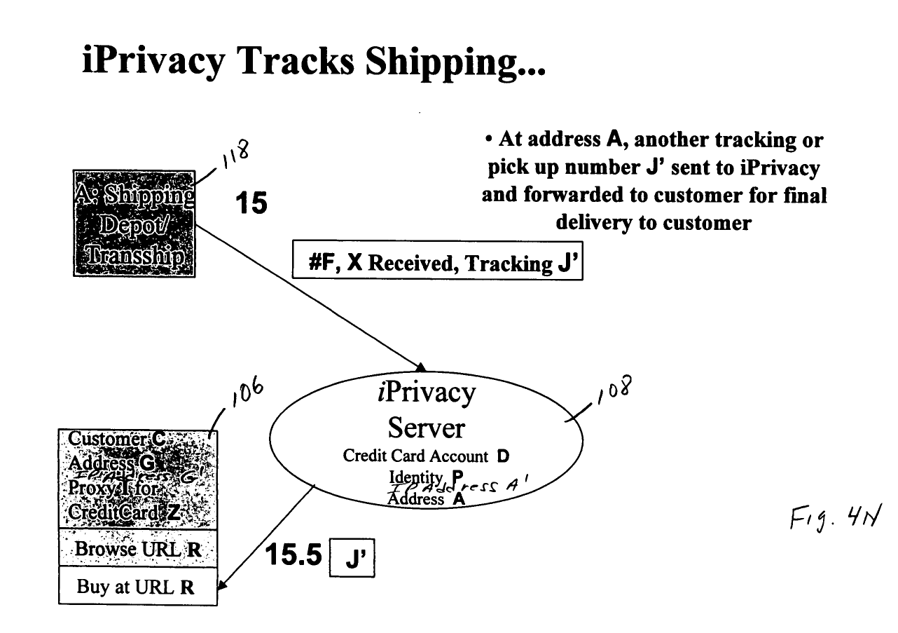

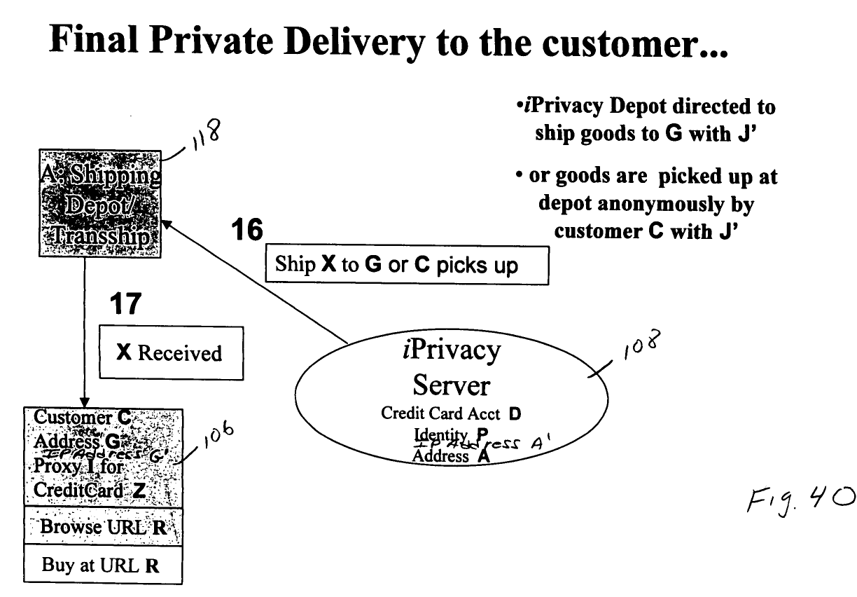

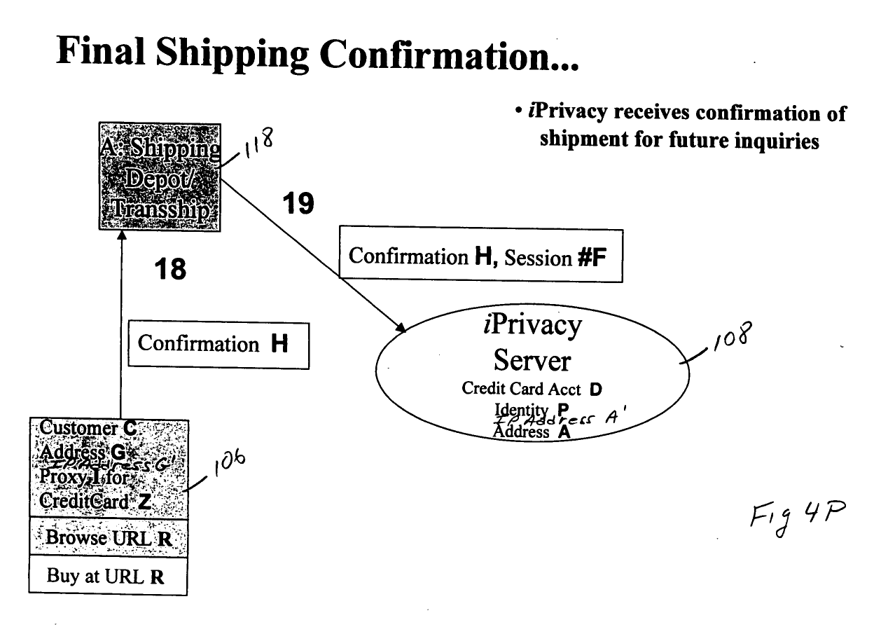

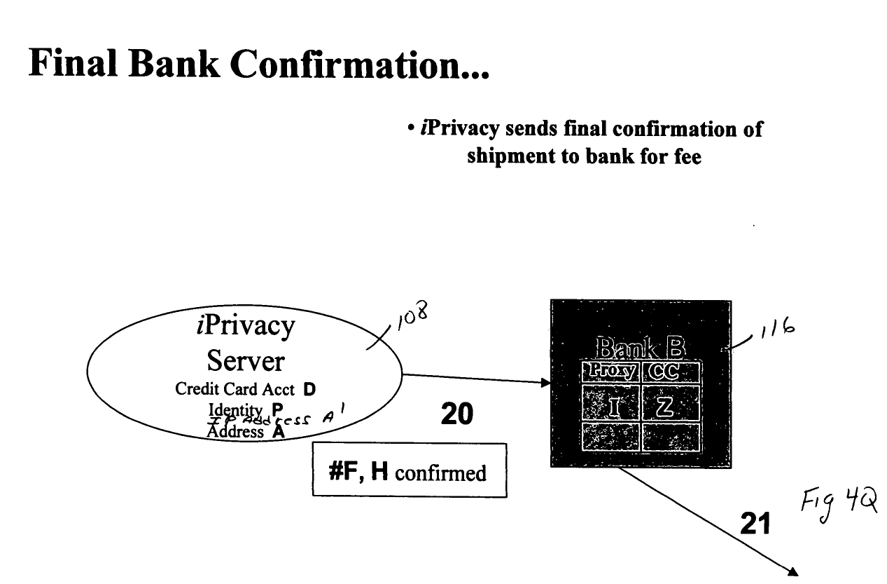

Operation of the system 100b is described with reference to FIG. 3B and FIG. 4. In the flow diagram of FIG. 4, the first party is referred to as “Customer C”, or simply “the customer”, the second party as “Retailer R”, or simply “the retailer”, the proxy party as “iPrivacy”, the third party as “Bank B”, or simply “the bank”, and the delivery facility 118 as “A: Shipping Depot/Transship”, or simply as “the depot”. In FIG. 4, the customer block is referenced by 106 consistent with the first party computer(s) 106 in FIG. 3, the iPrivacy block by 108 consistent with the proxy computer(s) 108 in FIG. 3, the retailer block by 110 consistent with the second party computer(s) 110 in FIG. 3, the bank block 116 consistent with the third party computer(s) 116 in FIG. 3, and the depot block by 118 consistent with the delivery facility 118 in FIG. 3A.

Referring to FIGS. 3B and 4, the proxy software 114 extends an API (the WWW browser 122) with software to monitor, filter and reroute interactions between the browser 122 and second party computers 110 (e. g., WWW servers). The proxy software 114 provides anonymizing transformations of these interactions to assure the customer's privacy, and eliminates from the transaction all explicit and implicit information identifying the customer and issues transaction information to the retailer with the proxy system's own identifying information, including financial charging information and a “first hop” shipping address from which the ordered good may be trans-shipped or held for customer pick up. The proxy software 114 monitors and filters all data exchanged between the customer computer 106 and the merchant computer 110 and removes any data that may compromise customer privacy. For example, cookies and agents dispatched by merchant computers 110 to customer computers 106 are eliminated.

Referring to FIG. 4, the customer computer 106 has a physical address G and an IP address G′, and user proxy software 114a by which the computer 106 accesses the Internet through a proxy computer 108 for anonymous WWW browsing and e-commerce. The user proxy software 114a is registered to Customer C under proxy identifier I, and can be invoked to with PINs, passwords, biometrics, etc. The proxy identifier may have one or more fields or other means to identify such users, and the proxy computer software may store data relating to such users. Also, more than one copy of user proxy software 114a may be loaded on the same PC and registered to different users, or loaded on different computers and registered to the same user.

Assume that the browser and the user proxy software are active on the customer computer 106 at Time T. Referring to FIGS. 4 and 4A, in step 1, the Customer C provides or clicks a URL R of a WebPage that he or she wants to visit, which is transmitted (step 2, FIG. 4B) to a proxy computer 108 having a physical shipping address (Depot) A and an IP address A′, a public proxy system identifier P, and a credit card account D with the bank B. As discussed herein, the user proxy software 114a strips at least the Customer C's IP address G′ from the message and substitutes the proxy computer's IF address A′. However, further filtering may be carried out by the user proxy software 114a and/or the proxy computer software 114b, as described below.

Referring to FIGS. 4 and 4C, in step 3, the proxy computer 108 transmits the altered message from the customer computer 106 to the retailer R, providing the retailer with the proxy system identifier P. The retailer responds in step 4 (FIG. 4D) with a return message to the proxy computer 108. The proxy computer 108 analyzes the message, and may filter or alter the message depending upon content before forwarding it to the customer computer 106 in step 5 (FIG. 4D). Assume that the message forwarded in step 5 includes a form portion, i.e., a portion which requests that the customer supply information such as order information, name, address, credit card information, etc. In one embodiment, the proxy computer software 114b on the proxy computer 108 may filter out form portions requesting private information and forward only the order portions of the form, which the user fills in (step 6, FIG. 4E). In another embodiment, the proxy computer 108 may forward the entire message and rely on user proxy software 114a on the user computer 106 or software transmitted with the message to warn or prevent a user from entering private information. In either case, a filled out form is returned (step 7, FIG. 4E) to the proxy computer 108, which generates a unique session number #F and provides it to the user computer 106 in step 7.5 (FIG. 4E).

A final shipping address designated by the first party and the shopping session number is stored in the secured address mapping (SAM) database 119 (FIG. 3B) along with tracking numbers and used later by the trans-shipper and depot to route the physical delivery correctly.

The total purchase price is determined from the good(s) ordered on the form (FIG. 4F), and the proxy computer 108 generates the ordered item(s) X and the price amount $Y. The proxy system has now generated “Item X, “Amount $Y”, “Proxy I” and “Session #F”. At this point, the proxy system operator obtains authorization to charge the user's credit card prior to forwarding order information to the retailer. In step 8 (FIG. 4G), the proxy computer 108 forwards to the bank B a secured message including the customer's proxy identifier I, the proxy's identity P, the amount of the requested transaction $Y, and the session (transaction) identifier #F, and requests credit authorization for the transaction. Depending upon business relationships, the retailer's identity R may have to be supplied (e.g., as a fraud prevention measure). The bank B already has the customer's account information which is accessed from the customer's proxy identifier I. (The customer's credit card number is not transmitted over the Internet, and is not subject to theft or misuse, thereby reducing fraud.) If authorization is denied (FIG. 4H), the session is ended, preferably by requesting the user to contact his, her or its bank.

In another embodiment (FIGS. 4G and 4K), the proxy identifier I and the customer's credit card number Z are held by the proxy system, and are sent to the bank B for credit authorization. The proxy system transacts with the retailer using the proxy system's credit card D. If the proxy system sends customer transaction information to the customer's bank B, and the proxy system sends transaction information to the proxy system's bank B′, then the proxy system will need a credit line with B′ (fourth party 124 in FIG. 3C) in advance of transacting.

If authorization is provided, the bank B in step 9 (FIG. 4I) authorizes credit for the concerned transaction and forwards authorization information W to the proxy computer 108, adds the following (FIG. 4J) to the previously generated order information (item identification X and amount $Y): the proxy system operator's proxy identifier P, the session identifier #F, the proxy system operator's credit card number D, the proxy system-operator's depot shipping address for delivery A. The user's identity transmitted to the retailer R is P # F, a unique proxy identity preventing the retailer from linking this transaction with any other transactions. In step 10 (FIG. 4J), the proxy computer 108 forwards this information to the retailer R. The proxy (depot) delivery address A is linked to the user's delivery address G in the secured address mapping (SAM) database 119 (FIG. 3B).

In step 11 (FIG. 4K), the retailer R requests authorization to charge the proxy system operator's credit card D. This request is made after the bank B approved the customer's credit in step 9 (FIG. 4I), which is represented in FIG. 4K by the request taking place at Time T+μ. If the proxy party and the first party have accounts with the same bank B, this request is made to bank B, as shown in FIG. 4. If not, the request is made to another bank B′ (FIG. 4K) with which the proxy party has an account. If the proxy party's credit is approved, in step 12 (FIG. 4L) the bank B (or B′) provides the authorization Q to the retailer.

At this point (FIG. 4M), all authorizations have been provided, and the retailer in step 13 provides the proxy computer 108 with shipper tracking number J for the shipment from the retailer to the shipping depot (the first hop), and/or the order number O, which the proxy computer 108 forwards to the user computer 106 in step 13.5. The tracking number J is also stored in the SAM 119 and linked to the user's address G and shopping session number #F. The retailer then ships the good in step 14 to the proxy system operator's shipping depot address A with labeling containing the proxy system operator's proxy identifier P and the session identifier #F. In step 15 (FIG. 4N), the shipping depot A acknowledges receipt of the shipment and forwards to the proxy computer 108 acknowledgement of receipt of the shipped good identified by the session number #F, and a second hop tracking number or pick-up number J′, also stored in the SAM database 119, and the proxy computer 108 forwards this information to the user computer 106 in step 15.5. Depending upon arrangements with shippers and the proxy shipping depot A, the same tracking number J may be used for both the first hop shipment to the proxy shipping depot A and the second hop shipment to the customer.

The proxy computer 108 in step 16 (FIG. 40) directs the depot A (a) to ship the good to customer address G designated by the first user to the proxy system if the good is to be to trans-shipped or (b) to hold it for pick-up (“C Picks Up”). The information needed for trans-shipping is contained in the SAM database 119 (FIG. 3B), which may be located at the delivery facility 118 or elsewhere. If the good is not to be trans-shipped, it is held at the depot A for pick-up, otherwise it is transshipped to the customer address G in step 17 (FIG. 40). If the good is held for pick-up, the proxy computer is informed when the good is picked up. If it is transshipped, in step 18 (FIG. 4P) confirmation of receipt (H) by the customer is provided to the shipping depot A, which informs (provides H plus #F to) the proxy computer 108 in step 19.

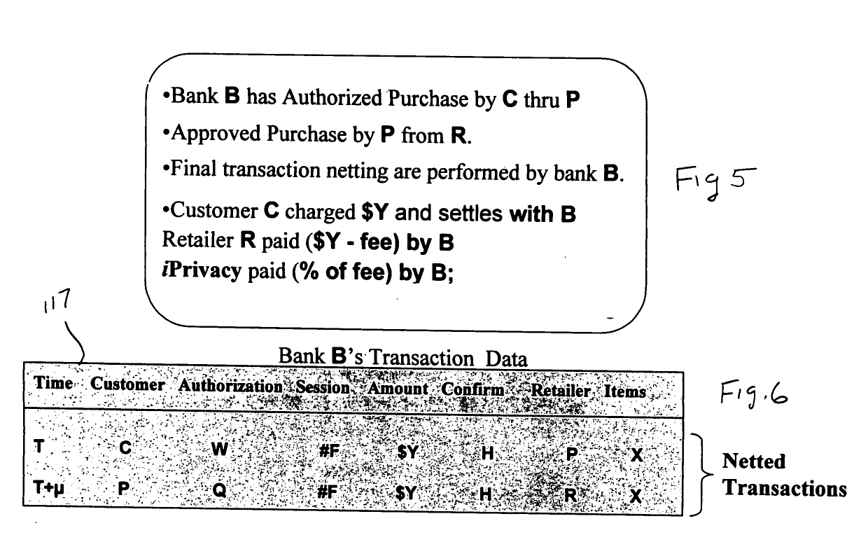

The proxy computer 108 confirms to the bank B in step 20 (FIG. 4Q) that the good was shipped by providing the session identifier #F and the confirmation H. In step 21, the bank B nets the transactions as illustrated in FIG. 5, including payment of a fee to the proxy party, as follows: the Customer C is charged $Y; and settles with the bank B; the retailer R is paid $Y less the customary transaction fee by the bank B; and the proxy party (iprivacy) is paid a percentage of the transaction fee by the bank B. The bank B's transaction data, stored in a transaction database 117 (FIG. 3B), is shown in FIG. 7, where time T indicates transactions relating to the Customer C, and time “T+μ” indicates transactions relating to the proxy party (iPrivacy). FIG. 7 shows the data generated by the transaction which the proxy party can store in the transaction database 115 (FIG. 3B), and where appropriate, make available to others.

The proxy tracking numbers J and J′ are provided via the SAM database 119 (FIG. 3B) and to the user through the proxy system or via email to the user for the user to track the delivery. The retailer R does not receive the second hop tracking number J′.

In the embodiment described above, the session identifier #F is the data key to the data record for the transaction.

Variations of the transaction represented in FIG. 4 are possible and contemplated. As discussed above, in another embodiment represented in FIG. 3C, two banks are involved: one as the credit card company of the user (third party) and the other as the credit card company of the proxy (fourth party).

FIG. 3B shows the authorization, crediting and debiting steps where one bank involved, and FIG. 3C where two banks are involved. FIG. 3F shows authorization, crediting and debiting where two banks are involved and the proxy party is eliminated from the authorization, crediting, debiting and liability chains. FIG. 3G shows authorization, crediting and debiting where no proxy is involved.

Referring to FIG. 4, the authorization steps 11, 12 are between the second party vendor and the proxy system operator's bank, and the authorization steps 8 and 9 are between the proxy system and the user's bank. The order of the authorizations 8, 9 and 11, 12 may be reversed if desired. The vendor charges the purchase price to the proxy system operator's bank and the proxy system charges the purchase price to user's bank, and netting provides the two banks and the proxy system with part of the bank fee. Depending upon the arrangement, identification of the good may be withheld from both banks and the identity of the vendor may be withheld from the user's bank.

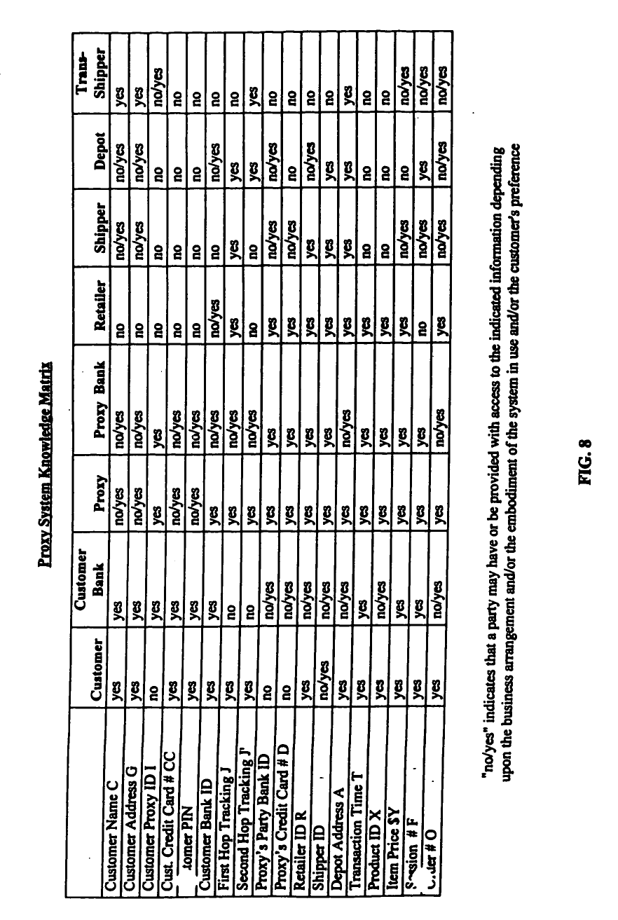

The table in FIG. 8 summarizes the transaction data available to various parties. Variations are possible regarding data available to the various parties to a transaction, some of which are indicated in the table shown in FIG. 8. The table in FIG. 8 is meant to be exemplary.

Referring to FIGS. 3, 3A-3C, the user proxy software 114a extends a user's WWW browser to monitor, filter and reroute interactions between the browser and WWW servers (retailers R). The user proxy software 114a and/the proxy computer software 114b provide anonymizing transformations of these interactions to assure user's privacy, as briefly discussed above and in more detail below.

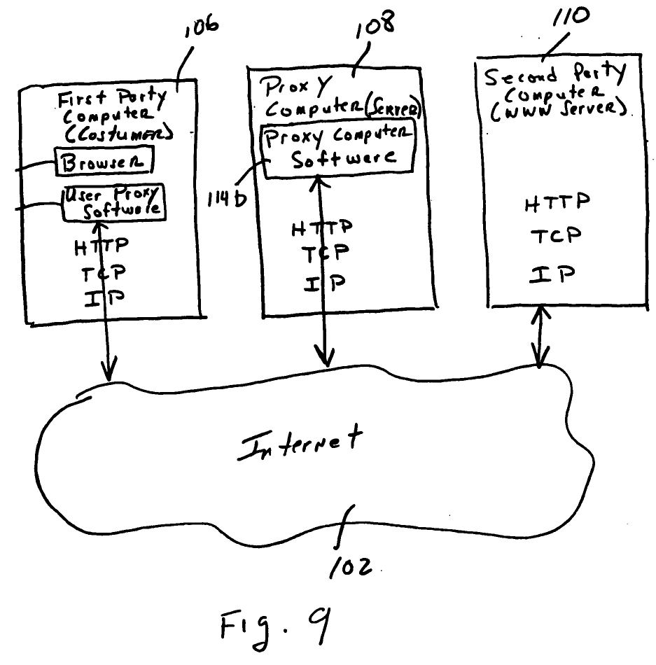

FIG. 9 depicts the various protocol layers of IP packets processed by first party (user) computers, proxy party computers and second party computers. With the user proxy software 114a active, the proxy computer software 114a strips the user computer's IP address G′ (FIG. 4) in cooperation with the user proxy software and substitutes the proxy computer's IP address (identifier A′), which redirects the messages to the respective destination WWW server (second party retailer computer 110). (The user computer's IP address G′ is needed by the proxy computer. Therefore, stripping is performed by the proxy computer software.)

In a preferred embodiment of the present invention, a true address label is generated at the point of origination (when it gets affixed to the package), but in such a way that the information about the true identity of the recipient is not revealed to the merchant. This might be done so that the real address is available only on the paper label that is affixed to the package. As a result, if the merchant wanted to obtain a record of the address, he would have to have staff sitting at terminals and typing or scanning in the information when the delivery company software generates the paper label. If the identity information is prevented from being easily electronically replicated, but available only via physical means, (e.g., human reading and typing) that might be a sufficient costly impediment, along with other contractual constraints, to prevent merchants from automatically learning the true identity and address of anonymous shoppers, making this the safest and easiest way to integrate with existing shipping systems.

Reference is now made to FIG. 1 which is a block diagram illustrating the operation and components of a system of a preferred embodiment of the present invention. To ensure that a customer's real name is not disclosed, a customer obtains from a bank or credit card issuer a proxy identity, with, minimally, a proxy credit card account and a proxy name. This information is loaded in a database 1104 and accessible by the customer's client computer 1106. Database 1104 may be available on a server computer 1108 and/or on the client computer 1106. The proxy name may be assigned by a bank or credit card issuer, or it may be generated by processor 1110 automatically as described below. The proxy identity may be stored in a digital wallet, which is software that works like a physical wallet during electronic commerce transactions. A digital wallet can hold a user's payment information, a digital certificate to identify the user, and shipping information to speed transactions, and may be resident at client computer 1106 and/or on server computer 1108.

The customer browses a merchant web site which provides a web form 1112 to be filled out by the customer with order information and identity information. The customer selects a proxy identity 1102 for submission to merchant web form 1112.

The customer notifies server 1108 by some means (e.g., by clicking a button or icon) that a private transaction utilizing proxy identity 1102 is about to occur. Proxy identity 1102 is authenticated and/or certified to be sure that the identity is valid. Server computer 1108 contacts an Authentication Server 1114, that is maintained with current information about customer proxy identities that are available for online purchasing. Server 1108 sends the proxy identity information to Authentication Server 1114, which either responds with an affirmative message (meaning the proxy identity is authentic and active) or denies the proxy identity. In the latter case, the customer is informed that the transaction cannot complete, and the session is ended. Alternatively, the authentication and/or certification of the proxy identity is performed at the client device (e.g., PC, handheld, etc.) using, for example, PIN's, passwords or other common means.

If Authentication Server 1114 approves the transaction, server 1108 generates a unique shopping session number, #F, 1115, and a proxy e-mail identity 1116 (e.g., 101@iprivacy.com), and stores the customer's real e-mail address in a Secured E-Mail Address Mapper Database (SEAM) 1104. Server 1108 then sends a message to client computer 106 that the transaction can proceed, and client computer 1106 assembles all relevant proxy information, including the proxy name (either bank assigned or generated from the shopping session number, e.g., iPrivacyCustomer#f), new shopping session number, #F, 1115, proxy e-mail address 1116, and a proxy shipping address, and enters it into a merchant web form 1112. This information is then transmitted to a merchant 1120 via communications links 1122. The proxy shipping address displayed in merchant web form 1112 may be formed by including e-mail address 1116 (or a portion thereof) in the name field, an encrypted Street Address (e.g., a string of alphanumerics that may be decrypted into a real street address, e.g., ABCDEFGH), an encrypted Apartment Number (if applicable), but may include the real city, state and the first five digits of the zip code. The “+4” digits of the “ZIP+4”, if provided, are also encrypted.

Merchant 1120 submits the customer's proxy financial information to a credit card authorization entity, which either authorizes or denies the transaction. If the transaction is denied, merchant web sites perform their typical functions and inform the customer that the transaction has failed. Otherwise, the transaction proceeds.

Merchant 1120 then directs software 1126 at shipping system 1128 to generate a label 1130 for the physical good(s) ordered by the customer. The shipping label printing software 1126 receives the proxy shipping information, and decrypts the street address, apartment number and “+4” zip code information, and a label generator 1132 prints physical label 1130. Software 1126 is constructed so that the decrypted information cannot be captured electronically but rather generates printer commands to generate printed characters with the real address information. The proxy name, e.g., iPrivacy-101, is not decoded into a real name, and is also printed on the label.

The delivery company takes receipt of the package for delivery, and carries and delivers the package to the recipient's address now printed on the label. A confirmation of the delivery is noted by the delivery company, and sent to the private shopping server signaling the completion and termination of the transaction. The delivery confirmation code may be stored for future reference in database 1104.

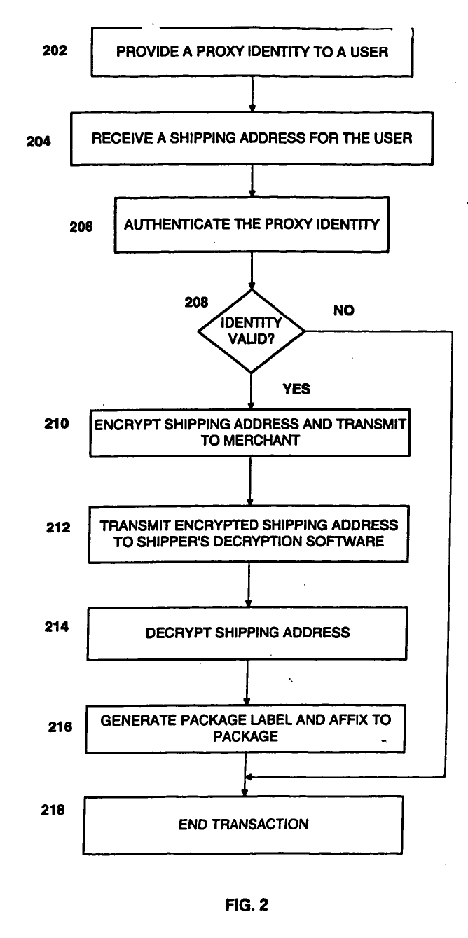

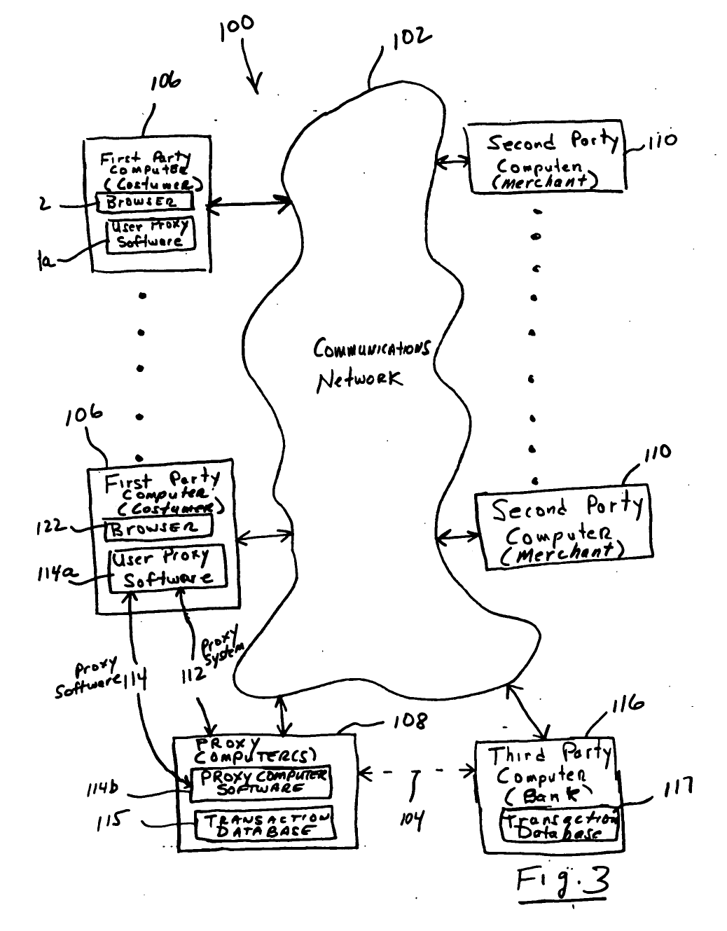

Reference is now made to FIG. 2, which is a schematic block diagram illustrating the steps in a preferred embodiment of the method of the present invention. In step 202, a user wishing to purchase a good from an online merchant is provided with a proxy identity, which may consist of a proxy name and a credit card account/number dedicated solely to online purchases. The user may be provided with a new and different proxy name for each online shopping session the user undertakes. The user provides his or her mailing address to a secure server in step 204. Prior to forwarding the user information to the merchant web site, the server authenticates the user's proxy identity (i.e., verifying the credit card information) in step 206. Alternatively, the server may generate a proxy identity (e.g., proxy name and e-mail address) for the user at the time of the transaction. In step 208, if the user's proxy identity is invalid, the transaction is terminated in step 218. If, however, the proxy identity is valid (i.e., the user is authorized to use a valid credit card account), the user's mailing address is encrypted and transmitted to the merchant web site, along with the proxy identity, in step 210. In an alternate embodiment, the user's credit card information is held locally at the user computer (e.g., client) and is not verified by the server. It should be pointed out that the entire address could be encrypted, or just the house number and street portion of the address field. In step 212, the user's encrypted shipping address is transmitted to the shipper. In step 214, decryption information, such as computer software, supplied to the shipper by the trusted entity maintaining secure server 1108 decrypts the mailing address, and in step 216, a package label with the user's true address generated. It should be emphasized that only the user's true address would be revealed on the package label, not the user's true name or e-mail address. It should also be understood, as one of ordinary skill in the art will recognize, that a variety of cryptographic algorithms can be used in implementing the present invention. For purposes of illustration and not limitation, one example of such a cryptography scheme is public key/private key encryption. In such an embodiment, encryption keys can be periodically rotated for additional security. This process is described by way of an example. Given the true identity of a customer who wishes to remain anonymous to web merchants:
Joe Smith
1000 Main Avenue
Des Moines, Iowa 77755
smith@myisp.com
   the customer would send to the merchant, via the web merchant's web form at the time of purchase, and through the order entry system, the following proxy identity:
iPrivacy 123456789012
ABCDEGFGHJOILKJILMSH
Des Moines, Iowa 77755
123456789012@iprivacy.com

Notice the Name field is proxied by a shopping session number, 1115. Alternatively, the printed label may replace the proxy name (e.g., iPrivacy 123456789012) with a proxy e-mail address or some other identifying information. The city, state and zip are transmitted, since the density of the population in a typical zip code is large enough to create anonymity, and the ADDRESS 1 field, typically holding number and street address has instead a CODE that encrypts or encodes the true address. When this proxy address is sent through the merchant's order processing system, ultimately that system sends an electronic message to the shipping system that generates the labels placed on packages. The shipping system software is typically supplied by delivery companies. When that shipping system receives this proxy address, it would use decryption information, such as a computer software program provided by the trusted entity maintaining secure server 1108, to decrypt the ADDRESS 1 field (i.e., house number and street) and generate a paper label placed on the package that appears:
iPrivacy 123456789012
1000 Main Avenue
Des Moines, Iowa 77755
123456789012@iprivacy.com

Thus, the true number and street address are recovered and printed on the label, but not the customer's true name or true e-mail address. Those two key pieces are still proxied. The only way a merchant can use this label-printed information is either a) scanning it, or b) having staff type it in, and then go to the costly process of finding who the customer may be on the basis of his address.

The essence of this process is that the banks or credit card issuers issue credit card accounts to their customers, which are used only for private online purchases. Users simply shop by filling out web forms with their proxy identity and proxy credit card. The transaction is authorized in the normal course of processing a credit card purchase. However, an “identity pre-authentication” is performed to ensure that the credit card account is used only with bank issued software and/or that the proxy identity and proxy credit card account have not been “turned off” by the bank. That authentication process can be implemented readily using standard “digital certificate” technology. Optionally, the identity pre-authentication step discussed above is performed using physical integrated circuit chip card (“IC card”) technology. These IC cards are physically delivered to customers and used with a card reader attached to a user's personal computer or hand-held device to further certify and authenticate the use of the credit card information. By delivering physical IC cards to consumers, banks may therefore deliver certificates or serial numbers more securely.

A proxy e-mail identity, e.g.SS#F@iprivacy.com, where “SS” stands for Shopping Session and “#F” is the unique shopping session number generated by the server, is generated for the customer each time he shops. If he wishes to have his behavior captured by a particular merchant, he can be assigned a proxy e-mail address, which is stored in a secured e-mail address mapper (SEAM) database, for periods of time longer than the lifetime of a transaction. The private credit card account can be used by a merchant to maintain a transaction history for a customer, but the customer will still remain anonymous. The merchant, however, cannot contact that customer via e-mail if/when the forwarding function associated with the proxy e-mail address is turned off. The proxy identity (e-mail, name, address, etc.) can be varied each time the private credit card account is used. Alternatively, a user may choose to reuse a prior proxy e-mail address previously provided to him. This proxy e-mail address lives as long as the shopping session/transaction lives, and is flushed from the system once the shipping company's confirmation code (H) is received. The shopping session number may be reused under certain circumstances such as subscriptions and/or installments. The reuse of the shopping session number is at the discretion of the authorizing bank. It is this e-mail address that is provided to merchants and the Secured E-mail Address Mapper (SEAM). It should also be understood that a web-based e-mail system could be implemented so that users would not have to disclose their true e-mail addresses at all. In this embodiment, a user could log into the web-based e-mail system and read the e-mail messages sent to his or her proxy e-mail address.

If the real address of each recipient includes an email address, the secure server 1108 creates an email proxy to facilitate the communication between the shipping company and the recipient (e.g., providing a tracking number, etc.). If an email is not available, the label may contain a pointer to a web server with the real information of the recipient. This web server provides access to a limited view of the secured transaction database 1104 (STD). (Alternatively, the shipping/delivery company may be given access to the STD). The delivery person can follow the link that is printed on the label and access the contact information. Instead of a URL, the label may contain an email address that provides similar functions, e.g., an e-mail to SS#F-i@iprivacy.com returns the contact information of the recipient, as long as it originates from authorized personnel.

Customers who shop at a web site must first open their digital wallet and click on “private” in their wallets to initiate an online pre-authentication of their proxy identity by server 1108. Banks and credit card issuers only need to provide a steady stream of information about proxy credit card accounts that have been deactivated or deleted. The integration task with the digital wallet is to provide the means of doing the pre-authentication when the user chooses the proxy identity. That step requires the server to generate a new shopping session number 1115 after authentication occurs, and create a proxy e-mail address 1116 at the client in the digital wallet.

Alternatively, printed label 1130 could include an identifier that serves as a proxy name for the customer and can be easily converted to an e-mail address. Consider the following label:
iPrivacy 123456789012
1000 Main Avenue
Des Moines, Iowa 77755
   The name field (e.g., iPrivacy123456789012) in the label above may be converted to a simple e-mail address as follows: 123456789012@iprivacy.com.

It is also desirable to encrypt a user's address, e.g., 1 MAIN STREET, so that the code is a) hard to break b) decoded fast and c) there are several different versions of the encryption that all decode to 1 MAIN STREET so that a single encoding can't be used to time correlate the user's buying behavior. The system should not present the same encryption string for the user's real address each time he/she buys at a web-site because the common string can be used to time correlate the user's transactions and/or once one address is breached, all records containing that same address encryption are breached.

For most web merchants, there is enough room in the address field of the web merchant web form to store the encrypted address and some other characters. This additional space in the web form can be used to randomly inject an error or false character into the real address, so that the resultant encrypted address will vary each time. That random error should be trivial to find and delete when the string is decrypted. For example, let “f” be an encryption function that behaves as a non-linear function that enccrypts an input string and is hard to invert without knowing a secret decryption function, f2. Thus, f1(x)=y, and f2(y)=x. By defining f1 to be a non-linear function then a slight perturbation to the input causes the function to generate a value that varies widely. Let f1 (“1 MAIN STREET”)=code 1 (e.g., 1A2B3C4D5E6F7G8H9I)

Now, if another character is injected into the string “1 MAIN STREET”, the resultant encrypted string should be very different from the string produced otherwise because f1 is non-linear. Thus, f1 (“1% MAIN STREET”)=code2 (e.g., X9Y8W7R6U5D4H3). Here the character “%” is injected into the string in the second character position. Notice that code 1 is very different from code2.

For decryption purposes, a decryption function, f2, applies a mathematical function inverting the encryption function f1, and deletes any characters that were injected by the encryption function f1. Thus, f2(code1)=f2(code2)=“1 MAIN STREET”. Thus, the “%” character which was injected to create code2 is deleted by f2 to produce the true address, “1 MAIN STREET”.

The “%” character was chosen in this example because it is a predefined printable character that does not typically appear in an address field. This, and other similar characters, e.g., “.!@#$%ˆ&*( )_+,” are injected in a controlled fashion into the client's real address field. These atypical characters would therefore look like “random” errors in an address field, but cause “1 MAIN STREET” to be encrypted with a widely varying set of encryption strings.

When an encrypted address is input into the decryption function by the printer software, the atypical characters are deleted from the string to produce the correct real address. Injecting “random errors” in a controlled fashion as described above will generate a finite number of encryptions per real address, but each will be widely variable, and hard to decrypt into the real address. Advantageously, the wide variety of encrypted strings produced for a single real address will prevent time correlation of user's behavior using a single string that otherwise would be provided for his real address.

There are several advantages to the present invention:
1. The integration task with the banks is greatly simplified. The integration entails little more than storing bank-generated proxy identities and new card accounts in a database accessible for authentication purposes. This data base application only needs updates from the bank when identities come and go.
2. Integration with current credit card transaction systems is trivial. What is submitted to the web form and the credit card acquirer is exactly what the card issuer/acquirer expects to see, the private identity and card number they have issued to a customer. The banks do not need to build any special integration or matching software to link multiple accounts.
3. A great deal of intelligence at the client to read and extract information from web forms is unnecessary. The chosen digital wallet technology simply fills forms with the proxy identity. Financial authorization (e.g., credit limits, fraud detection) are all performed as standard practice today. The wallet technology includes—password protections, and the pre-authentication step helps ensure fraud reduction.
4. Integration with the digital wallet/form filler is greatly simplified. The integration task entails contacting the server when the wallet is opened and a private identity is selected to: a) authenticate the user's proxy identity and b) if authenticated, generate a new shopping session number, create a proxy e-mail account on the SEAM (Secured E-mail Address Mapper) server (with forward to the user's real e-mail uploaded from the wallet), and download to the client wallet the new proxy e-mail identity to be used in filling the web forms.
5. Authentication task is greatly simplified. Standard certificate schemes can be used.
6. Integration with shipping systems is trivial. By printing physical labels with the real address of the customer, there is no need for delivery company systems to be electronically integrated with a SEAM database.
7. Tax computations are simple. Since the actual city and state where delivery is to be made are revealed to the merchant during the transaction, merchants can easily apply the appropriate tax rate for purchases. This is an important issue for law-makers who are debating schemes for taxing e-commerce transactions.

An additional problem that some merchants may encounter is that they may not have shipping contracts with a shipping company that has implemented the decoding software needed for private shipping. However, even if a merchant has no relationship with a shipping company that employs the necessary decoding software, private shipping can still be provided by shipping to a depot. For example, at some web-sites it may not be possible to ship via Federal Express™ if United Parcel Service (UPS) has an exclusive deal with the merchant. However, shipping via the United States Postal Service (USPS) is an option at all web-sites as a default. (Even if all shipping companies are available at a web-site, users generally cannot choose which one to use for shipping their merchandise.) Therefore, a web-site may have an exclusive shipping contract with UPS, even though UPS does not provide private shipping. If a user transacting on this web-site wishes to ship privately, there would be no way to generate the encrypted proxy address label discussed above. The solution to this problem is to use the United States Postal Service (USPS) as a default private shipping carrier.

For example, if the true shipping address is:
John Smith
1 Main Street
Kansas City, Mo. 11122

The private shipping label, with the USPS as the default private shipping carrier would be:
iPrivacy-101 ABCDEFGHIJ
P.O. Box 99999
Kansas City, Mo. 11122
   where iPrivacy-101 is the proxied name of the user, ABCDEFGHIJ is the encrypted street address, and P.O. Box. 99999 is a standard caller service post office box, owned by an entity providing the private transaction service and operated by the USPS at each and every post office nationwide. The number assigned to the post office box in a particular area may be a function of the area's actual zip code.

Now, if Federal Express supports private shipping and Federal Express decoding software is enabled at the web-merchant, when this label information is sent to the Federal Express software, it will decode:
iPrivacy-101
1 Main Street
Kansas City, Mo. 11122
   Notice in the decoded label above that the post office box has been removed and the true address has been decoded for shipping to the user's home.

In the alternative, if Federal Express decoding software is not enabled at the web-merchant, then the label generated will include the post office box number (P.O.B. 999999) which a) forces the USPS to ship from the web-merchant (because Federal Express and UPS cannot ship to post office boxes) and b) the package is held at the post office in zip code 11122 for customer pick up. In this scenario, decoding software at the user's post office can produce the user's home delivery address so that the package may be delivered to the user's home by the USPS, or, alternatively, a postcard is printed by the decoding software and carried home to the user.

In addition to the problem discussed above, as a security measure, some web-sites require that the shipping address for an order be the same as the billing address associated with the credit card used for payment. Thus, at these sites, items may only be shipped to the billing address associated with the credit card. In such cases, if a user's shipping address is encrypted as above for privacy reasons, the shipping address will not match the user's billing address, and the user will not be able to shop and ship privately.

This problem is solved as follows. As known in the art, credit card payments require an authorization from the credit card issuer (e.g., bank) that includes a check of the billing address to ensure that it conforms to the address on file for the customer. This check requires sending the credit card number, expiration date, and a portion of the billing address to the credit card issuer for verification and authorization of the transaction.

The user's billing address is checked via a process known in the credit card industry as Address Verification System (AVS). According to this process, a portion of the billing address is extracted from the user specified billing address by a well-known algorithm: the first five leading numerals in the address field, excluding dashes, slashes, and periods, are extracted before a blank space is reached. The zip code is then added to this string to produce the “AVS string” for AVS processing. For example, if the billing address specified is:
1 Main Street
Kansas City, Mo. 11122
   The AVS string produced for AVS processing is “1, 11122”. If the billing address is
102-23^{nd} Street
Kansas City, Mo. 11122
   The AVS string produced for AVS processing is “10223,11122”.

Therefore, in order to ensure that the encrypted shipping address will pass the AVS process, and the private shipment will be processed and received by the user, a user's shipping address will be encrypted as follows. Given a user's true name and address:
John Smith
102-232^{nd} Street
Kansas City, Mo. 11122

The private shipping information will be:
iPrivacy-101
10223 ABCDEFGH
P.O.B.999999
Kansas City, Mo. 11122

Combining all of the steps described above, this proxy address:
1) Proxies the name of the user (iPrivacy-101)
2) Proxies the street address field, but includes the numerical information necessary (10223) to satisfy the AVS process for billing address verification.
Note that the portion of the street address reading “ABCDEFGH” may be decoded by private shipping software enabled at the web-site.
3) Provides a standard “caller service” post office box number (999999) to allow for private shipment to the post office box by the USPS if decoding software is not enabled at the web-site.
   In one variation of this embodiment, the encrypted portion of the street address (“ABCDEFGH”) is not included in the address so that the intended point of delivery is the post office box.

There is, however, an additional problem created by the post office box pick-up scenario. An unauthorized third party may intercept the communication between the user and the retailer and attempt to pick up the privately shipped package at the post office. The post office would, therefore, need to verify or authenticate the identity of the private user before releasing the package. To authenticate the user, the post office can ask for proof of address (via driver's license or some other document) in order to match the street number on the package label (e.g., 10223 in the example above) with the address on the identification document. In addition to a driver's license, several other types of documents can be used to verify a user's address for identification purposes such as a utility bill, passport, or any other document generally acceptable to the post office.

Address verification is the preferred mode of identification, but in alternate embodiments, other means of identification, such as a portion of the user's social security number, can be included as a prefix on the proxied address field, and the user could then display his or her social security card at the post office to authenticate himself or herself as the proper recipient of the package. For example, if the user's social security number is 123-45-6789, the label could be modified to read:
iPrivacy-101
10223 ABCDEFGH
P.O.B. 999999-123-45
Kansas City, Mo. 11122
   As shown above, the first five digits of the user's social security number, e.g., “123-45”, have been added to the address field, appearing after the post office box number. These digits could also be printed on some other field of the label. The user would then show their social security card displaying their social security number, e.g., 123-45-6789, to verify their identity and pick up their package.

In another embodiment, a portion of the user's proxy credit card account number could be printed on the label as a means of verification. The server would then generate and send an e-mail message to the user's proxy e-mail address that includes the proxy shipping information and a portion of the user's proxy credit card number (e.g., the last four digits). The last four digits of the user's proxy credit card number would appear on the e-mail, and the user can print out the e-mail message and present it to the post office, together with the proxy credit card, to verify that the user is the legitimate owner of the package.

Alternatively, a secret code can be securely provided to both the user and the post office, and the user would need to match the secret code to the same code provided to the post office. This embodiment may require some alteration of substantive post office procedures because the post office would need to receive the secret code over a secure channel.

As described above, the invention provides for private shipping of goods as a single delivery. In the most general case, however, a transaction may involve multiple goods purchased across many retailers and delivered to multiple locations. The person purchasing goods on the Internet may be different from the person receiving the goods. The concepts discussed above can be used with separate deliveries to multiple addresses from a single web retailer. Again, the shopping session number, SS#F, will go to all shipping addresses (as in the case with a single delivery). However, to be able to distinguish among the various shipments, SS#F has two parts: one which is common across all shipments and is the same as the transaction number, and one that distinguishes each shipment. For example, SS#F-1, SS#F2, may be used for the first and second shipment in a series of shipments, respectively. Encoding and decoding addresses by the shipping system is performed as in the case of a single shipment. In this case, the user's digital wallet and the secured transaction server (STS) send a new encrypted label to the shipper software for every SS#F-i that is generated, i.e., for every real shipping address.

The invention processes transactions that span across multiple shops in a similar manner. Provided the STS can access the shipping software of all merchants, two scenarios are possible:
1) STS generates a single SS#F-i for each delivery address. In this case, different merchants get the same encrypted labels for each recipient. (This is easier to integrate in malls).
2) STS generates different SS#F-i for each delivery address for each recipient. Thus, the same recipient will have two distinct SS#F-i's with two different retailers. (The advantage is that it's easier to track when the transaction is complete: when the shipper sends i confirmation messages to STS).

In addition to the problems discusses above, delivery may fail for other reasons. For example, users who live in multiple unit buildings (e.g., apartment buildings) may neglect to input their suite number or apartment number in the address field on a web merchant form. Without such information on a shipping label, delivery companies are forced to rely on the user's name to effect delivery. In the present invention, the user's name does not appear on the shipping label, so the user must take special care to enter his or her apartment number or suite number. When inputting the shipping address information into the digital wallet, the software system can make sure the user enters his or her apartment number to reduce the chances that the apartment number is forgotten. Additional reminders at the time users enter the data should substantially reduce the problem. Another alternative is to display the address label as it would be printed via a pop up window each time the user makes a purchase and uses his wallet along with the proxy name as it will appear on the label placed on the parcel. That information can be held at the client PC as a reminder when the package arrives to help identify the recipient of the parcel. Alternatively, an e-mail containing the proxy name can be generated and sent to the user to serve as a proof of purchase and help identify the recipient of the parcel.

Another issue to consider is whom do customers call when they don't receive their parcel? The merchant from whom they purchased the parcel would be the logical entity to contact. The user may refer back to the transaction information stored on his behalf at the client and/or a transaction database located on a secure server. Part of the user experience may include notes or reminders about this issue with directions to the user to whom he should call in the case of failed deliveries.

Yet another issue to consider in private shipping is where does the delivery company send undeliverable or refused parcels? For example, a back-ordered item may arrive after the ordering party has moved. Under typical practice today, the delivery company obligation is completed when the parcel is physically delivered to a mailbox, or hand delivered to some person answering a door and taking receipt of the package.

To ameliorate this problem, the delivery company may return the package to the retailer. In such cases, the transaction is still active (not “retired”) until a final delivery confirmation is received from the delivery company and so the retailer would have available a means to contact the user to inform them of the problem. Furthermore, because the proxy email address is available on the printed label, the delivery employee or letter carrier may send email to the anonymous customer informing them of the delivery problems with directions to the local post office or delivery depot center where the package may be retrieved.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

What is claimed is:

1. A method for providing private shipping of items to users purchasing goods on a computer-based communications network comprising the steps of:
providing a proxy identity to a user;
receiving a shipping address for the user;
partially encrypting the user's shipping address;
transmitting the proxy identity and encrypted shipping address to a merchant; and
providing decryption information to a shipper
whereby upon receipt of the encrypted shipping address from the merchant, the shipper can use the decryption information to decrypt the address and generate a package label bearing the true shipping address of the user so that the merchant is prevented from electronically capturing the true identity of the user.

2. The method of claim 1, wherein the proxy identity comprises a proxy name and a proxy credit card account number.

3. The method of claim 2, wherein the step of issuing a proxy identity includes issuing a physical integrated circuit card to the user.

4. The method of claim 3, further comprising the step of authenticating the user's proxy identity.

5. The method of claim 4, wherein the step of authenticating the proxy identity includes reading the integrated circuit card via a card reader.

6. The method of claim 2 wherein a new proxy name is generated for each transaction by the user.

7. The method of claim 1 wherein the communications network is the Internet.

8. The method of claim 1 wherein the user's proxy identity is stored in a digital wallet.

9. The method of claim 1, wherein the encrypted shipping address contains sufficient information to allow the merchant to calculate an appropriate transaction tax.

10. The method of claim 1, further comprising: maintaining a secure database of user transaction information; and providing access to the database to a shipper to resolve a shipping problem.

11. The method of claim 10, wherein the transaction information includes instructions for returning undeliverable items.

12. The method of claim 1, wherein the user's encrypted shipping address contains an identifier that may be used as an electronic mail address to contact the user.

13. The method of claim 1, further comprising generating a unique shopping session identification number.

14. The method of claim 13, wherein the encrypted shipping address is a function of the shopping session identification number.

15. The method of claim 1, wherein the encrypted shipping address is a function of time.

16. The method of claim 1, wherein the encrypted shipping address includes an index number for cross-reference to a database of real shipping addresses.

17. The method of claim 1, further comprising randomly inserting at least one atypical textual character into the true shipping address before encrypting the shipping address.

18. The method of claim 1, further comprising:
receiving a privacy level selection from the user for a shipment; and selecting an encryption algorithm for the user's shipping address based upon the selected privacy level.

19. A method for providing private shipping of items to users purchasing goods on a computer-based communications network comprising the steps of:
providing a proxy identity to a user;
receiving a shipping address for the user;
partially encrypting the user's shipping address;
appending a post office box number to the user's encrypted shipping address;
transmitting the proxy identity and encrypted shipping address to a merchant;
whereby upon receipt of the encrypted shipping address from the merchant, the shipper can generate a package label bearing the partially encrypted mailing address of the user with the post office box number so that the merchant is prevented from electronically capturing the true identity of the user.

20. A system for providing private shipping of items to users purchasing goods on a computer-based communications network comprising:
a secure server computer including a processor configured to generate a proxy identity for a user, receive a shipping address for the user, and partially encrypt the user's shipping address;
a database configured to store user identity information and transaction data; and
a communications link for transmitting the proxy identity and partially encrypted shipping address to a merchant;
so that the merchant is prevented from electronically capturing the true identity of the user.

21. The system of claim 20, wherein the processor is further configured to generate a unique shopping session identification number.

22. The system of claim 21, wherein the user's encrypted shipping address is a function of the shopping session identification number.

23. The system of claim 20, wherein the user's encrypted shipping address is a function of time.

24. The system of claim 20, wherein the encrypted shipping address includes an index number for cross-reference to a database of real shipping addresses.

25. A method for providing private shipping of items to users purchasing goods on a computer-based communications network comprising the steps of:
providing a proxy identity to a user;
receiving a shipping address for the user;
partially encrypting the shipping address so that the numerical information required for authorization under the Address Verification System is preserved;
transmitting the proxy identity and encrypted shipping address to a merchant; and
providing decryption information to a shipper whereby upon receipt of the user's proxy identity and Address Verification String from the merchant, a credit card issuer can authorize the purchase, and upon receipt of the encrypted shipping address from the merchant, the shipper can use the decryption information to decrypt the address and generate a package label bearing the true shipping address of the user so that the merchant is prevented from electronically capturing the true identity of the user.

26. The method of claim 25, wherein the proxy identity comprises a proxy name and a proxy credit card account number.

27. The method of claim 25, wherein the communications network is the Internet.

28. A method for providing private shipping of items to users purchasing goods on a computer-based communications network comprising the steps of:
providing a proxy identity to a user;
receiving a first shipping address for the user;
substituting a second shipping address for the user's first shipping address;
transmitting the proxy identity and second shipping address to a merchant; and
providing address mapping information to a shipper
whereby upon receipt of the second shipping address from the merchant, the shipper can use the address mapping information to generate a package label bearing the first shipping address of the user so that the merchant is prevented from electronically capturing the true identity of the user.
